(19) United States
(12) Patent Application Publication
(10) Pub. No.: US 2004/0183266 A1
(43) Pub. Date: Sep. 23, 2004

(54) Wheeled container coupling system

(76) Inventors: Robert F. Cambiano, La Marque, TX (US); David Dunn, Legue City, TX (US)

Correspondence Address: William P. Glenn, Jr., 2102 Mechanic Street, Suite 205, Galveston, TX, 77550, US

(21) Appl. No.: 10/393,856

(22) Filed: Mar. 21, 2003

(51) Int. Cl. B62B 1/00

(52) U.S. Cl. 280/47.26

(57) ABSTRACT

The present invention is directed toward a container coupling system that releaseably couples a modular container to at least one carried container. Coupling is achieved by a coupling assembly which includes a first coupling portion and a bearing region are located on a loading side of a lifting container; and a second coupling portion and a contact region are located on a carried container. A coupling assembly couples a lifting container with a carried container by releaseably engaging a first coupling portion with a corresponding second coupling portion. Additional embodiments of a modular container include a removable frame and lift plate assembly.

### TECHNICAL FIELD

The present invention relates generally to wheeled container coupling assemblies for wheeled containers. More specifically the present invention relates to coupling a container to a wheeled container for ease of moving both containers by the wheels of the wheeled container.

### BACKGROUND ART

In general, wheeled containers have been used to alleviate the need to lift and carry the loads within the containers. Wheeled containers come in a variety of different shapes and sizes. The most common configuration is a two-wheeled container which can be best described as a container integral to a two wheeled dolly. The lift plate of a traditional dolly is integral with the bottom of a two-wheeled container. The frame and handle of a traditional dolly is integral with an outer wall of a two-wheeled container container. Both the two-wheeled container's bottom and at least the frame side of the container are of sufficient thickness to hold a load when is tilted onto its wheels and rolled about an adjacent horizontal surface. A user is able to transport a load so long as it is able to fit within the two-wheeled container.

Unfortunately, when a user has a number of wheeled containers to be moved to a common area, each must be tilted and rolled to the new location. Similarly, the maximum size of a load to be carried by a traditional wheeled container is limited by the size of the container. If the load is unable to fit inside the container, then an alternative means of transport must be used.

Two common approaches to solve the simultaneous movement of containers exist. The first approach requires the containers to be stacked vertically. The second approach calls for the hitching of the wheeled containers together in a train, not unlike rail cars.

The vertical stacking of containers is limited by the dimensions and weight of the containers to be stacked. First, containers to be stacked must be designed or at least able to nest inside of each other. Second, the volume of loads to be carried in stacked containers must be significantly less than the volume of the wheeled containers. In other words, there must be a significant amount of volume of a lower container available to receive a corresponding container. Third, the weight distribution of the loads to be carried must be carefully checked to prevent instability of the stacked containers. Too much weight at a significant distance above the wheels can cause instability of the vertically stacked containers. Fourth, the stacking of containers is limited by the height to which containers are stacked above any maneuvering handle used to roll the wheeled container. Finally, the stacking and unstacking of containers (loaded or otherwise), requires a significant amount of effort to lift and insert a container into another. Likewise, a significant amount of effort is required to remove a vertically stacked container from another. Especially if the stacked container is loaded.

An alternative solution for simultaneous movement of wheeled containers is described in U.S. patent application Publication 2002/0014488 A1 attributed to Schermel (hereinafter Schermel '488 publication). The solution set forth in the Schermel '488 publication is limited to use on wheeled containers and requires the coupling of handles. Furthermore, by training wheeled containers, the maneuverability and stability of a train of coupled wheeled containers is limited by the multiple set of wheels in contact with the ground and the ability of any handle couplings to withstand lateral forces as adjacent coupled containers negotiate turns.

In view of the above described deficiencies associated with container coupling systems, the present invention has been developed to alleviate these drawbacks and provide further benefits to the user. These enhancements and benefits are described in greater detail herein below with respect to several alternative embodiments of the present invention.

### SUMMARY OF INVENTION

The present invention in its several disclosed embodiments alleviates the drawbacks and deficiencies described above with respect to conventional wheeled containers and the coupling of such containers. The present invention incorporates several additionally beneficial features.

It is one object of the present invention to provide a coupling system that allows the coupling of at least one carried container to a lifting wheeled container.

It is another object of the present invention to provide a coupling system that allows the coupling of at least two wheeled containers.

It is another object of the present invention to provide a coupling system that allows the carriage of at least one carried container by a lifting wheeled container.

It is another object of the present invention to provide a coupling system that allows a load to be carried external to a wheeled container.

It is another object of the present invention to provide a coupling system that allows the coupling on dissimilar coupling assemblies.

It is another object of the present invention to modify existing containers (wheeled and otherwise) to include a container coupling system that allows a container to be carried by a wheeled container.

It is a further object of the present invention to modify existing containers (wheeled and otherwise) to include a container coupling system that allows a wheeled container to carry other containers and loads.

The beneficial objects and effects described above apply generally to each of the exemplary devices and mechanisms disclosed herein of the coupling system. The specific structures through which these benefits are delivered will be described in detail herein below.

### BRIEF DESCRIPTION OF THE DRAWINGS

The invention is described in greater detail in the following examples and with reference to the attached drawings, in which:

FIG. 1 is a plan view of a pin and receiver coupling system coupling two wheeled containers together.

FIG. 1a is a plan view of a pin and receiver coupling system incorporating a horizontal bumper.

FIG. 2 is a perspective view of a modular wheeled container with a lid and a pin and receiver coupling system.

FIG. 2a is a perspective view of another embodiment of a modular wheeled container with a pin and receiver coupling system.

FIG. 3 is a perspective view of a pin and receiver coupling assembly.

FIG. 4 is a perspective view of another embodiment of a pin and receiver coupling assembly.

FIG. 4a is a perspective view of another embodiment of a pin and receiver coupling assembly with a guide.

FIG. 5 is a plan view of a container with a pin and a handle receiver.

FIG. 6 is a plan view of a pin and handle receiver coupling assembly coupling two containers together.

FIG. 7 is a plan view of a container with a pin adjacent to a cavity and a handle receiver.

FIG. 8 is a plan view of a pin and receiver coupling assembly with a portion of a handle receiver inside a cavity.

FIG. 9 is a plan view of a container with a pin set in a cavity and a handle receiver.

FIG. 10 is a plan view of a pin, cavity and receiver coupling assembly with a portion of a handle receiver inside a cavity.

FIG. 11 is a plan view of another embodiment of a pin adjacent to a cavity and a handle receiver.

FIG. 12 is a plan view of another embodiment of a pin, cavity and receiver coupling assembly with a portion of a handle receiver inside a cavity.

FIG. 13 is a plan view of another embodiment of a pin and handle receiver with a pin located at an end of a hinged hook.

FIG. 14 is a plan view of another embodiment of a pin and handle receiver assembly with a portion of a handle receiver coupled to a pin located at an end of a hinged hook.

FIG. 15 is a perspective view of container coupling system coupling a non-wheeled carried container to a wheeled lifting container.

FIG. 16 is a perspective view of a modular wheeled container with horizontal coupling bars.

FIG. 16a is a perspective view of another embodiment of a modular wheeled container with horizontal coupling bars and a lower frame receiver.

FIG. 17 is a perspective view of a container with a horizontal coupling bar having a bulbous cross section.

FIG. 18 is a plan view of a container coupling system with horizontal coupling bars, each horizontal coupling bar having a bulbous cross section.

FIG. 19 is a perspective view of a container with a horizontal coupling bar having a polygonal cross section.

FIG. 20 is a plan view of a container coupling system with horizontal coupling bars, each horizontal coupling bar having a polygonal cross section.

FIG. 21 is a perspective view of a container with a horizontal coupling bar having another embodiment of a polygonal cross section.

FIG. 22 is a plan view of a container coupling system with horizontal coupling bars, each horizontal coupling bar having another embodiment of a polygonal cross section.

FIG. 23 is a perspective view of a container with a horizontal coupling bar having a “T” cross section.

FIG. 24 is a plan view of a container coupling system with horizontal coupling bars, each horizontal coupling bar having a “T” cross section.

FIG. 25 is a perspective view of a container with a horizontal coupling bar having another embodiment of a “T” cross section.

FIG. 26 is a plan view of a container coupling system with horizontal coupling bars, each horizontal coupling bar having another embodiment of a “T” cross section.

FIG. 27 is a perspective view of a handling side of a modular wheeled container with a horizontal coupling bar and receiver.

FIG. 28 is a perspective view of a loading side of a modular wheeled container with a horizontal coupling bar and receiver.

FIG. 29 is a perspective view of a modular wheeled container with a pin and handle receiver and lift plate assembly.

FIG. 30 is a plan view of a hinged coupling handle and coupling bar system coupling two wheeled containers.

FIG. 31 is a perspective view of a handling side of a modular wheeled container with a coupling bar.

FIG. 32 is a perspective view of a handling side of a modular wheeled container with another embodiment of a coupling bar.

FIG. 32a is a perspective view of a coupling handle and coupling bar system.

FIG. 33 is a plan view of a coupling handle system coupling two wheeled containers.

FIG. 33a is a plan view of a coupling handle.

FIG. 33b is a plan view of another embodiment of a coupling handle.

FIG. 33c is a plan view of another embodiment of a coupling handle.

FIG. 33d is a plan view of another embodiment of a coupling handle.

FIG. 33e is a plan view of another embodiment of a coupling handle.

FIG. 34 is a plan view of another embodiment of a coupling handle system coupling two wheeled containers.

FIG. 34a is a perspective view of another embodiment of a coupling handle system.

FIG. 34b is a perspective view of another embodiment of a coupling handle system.

FIG. 35 is a plan view of another embodiment of a coupling handle system coupling two wheeled containers.

FIG. 35a is a perspective view of another embodiment of a coupling handle system.

FIG. 35b is a perspective view of another embodiment of a coupling handle system.

FIG. 35c is a perspective vew of another embodiment of a coupling handle system.

FIG. 36 is a perspective view of another embodiment of a coupling handle system with a pin and a receiver.

FIG. 36a is a plan view of another embodiment of a coupling handle system.

FIG. 37 is a perspective view of another embodiment of a coupling handle with a pin and a lid hatch.

FIG. 38 is a perspective view of another embodiment of a coupling handle with a lid latch and a coupling bar.

FIG. 39 is a perspective view of a modular wheeled container with an embodiment of a coupling handle system with a pin and a lid hatch.

FIG. 40 is a perspective view of a modular wheeled container with an embodiment of a coupling handle system with a pin, a lid hatch, and a coupling bar.

FIG. 41 is a perspective view of a removable lift plate assembly.

FIG. 42 is a perspective view of another embodiment of a removable lift plate assembly.

FIG. 43 is a perspective view of an removable articulating lift plate assembly.

FIG. 44 is a perspective view of another embodiment of a removable articulating lift plate assembly.

FIG. 45 is a perspective view of an articulating lift plate assembly.

FIG. 46 is a perspective view of another embodiment of an articulating lift plate assembly.

FIG. 47 is a perspective view of another embodiment of an articulating lift plate assembly.

FIG. 48 is a perspective view of another removable articulating lift plate assembly.

FIG. 49 is a perspective view of another removable articulating lift plate assembly.

FIG. 50 is a perspective view of another articulating lift plate assembly.

FIG. 51 is a perspective view of another removable articulating lift plate assembly.

FIG. 52 is a perspective view of another articulating lift plate assembly.

FIG. 53 is a perspective view of sliding and articulating lift plate assembly.

FIG. 54 is a plan view of a modular wheeled container with a removable articulating lift plate assembly with strapping.

FIG. 55 is a perspective view of a removable articulating lift plate assembly with strapping.

FIG. 56 is a plan view of a wheeled container with a removable container coupled to a wheeled frame by a pin and a receiver coupling system.

FIG. 57 is a perspective view of a modular wheeled container with removable containers coupled to a wheeled frame by a pin and receiver coupling system.

FIG. 58 is a plan view of a modular wheeled container with a removable frame having an articulating lift plate assembly.

FIG. 59 is a perspective view of a modular wheeled container with a removable frame having an articulating lift plate assembly.

FIG. 60 is a plan view of a modular wheeled container with a pin and receiver coupling system and a lower frame receiver.

FIG. 60a is a plan view of a removable frame with a horizontal coupling bar and a frame pin.

FIG. 60b is a plan view of a removable frame with a coupling pin and a frame pin.

FIG. 60c is a plan view of another embodiment of a removable frame with a coupling pin and a frame pin.

FIG. 60d is a plan view of removable frame with an articulating lift plate assembly and a frame pin.

FIG. 61 is a plan view of a modular wheeled container with a pin and receiver coupling system and another embodiment of a lower frame receiver.

FIG. 61a is a plan view of a removable frame with an upper frame receiver, a horizontal coupling bar, an articulating lift plate assembly, and a lower coupling bar.

FIG. 61b is a plan view of another embodiment of a removable frame with an upper frame receiver, an articulating lift plate assembly, and a lower coupling bar.

FIG. 62 is a modular view of a wheeled container with handles and a lower frame receiver.

FIG. 62a is a plan view of another embodiment of a removable frame with a frame hook, a frame pin, and an articulating lift plate assembly.

FIG. 62b is a plan view of another embodiment of a removeable frame with a frame hook, a frame pin, and a coupling bar.

FIG. 62c is a plan view of a removable frame with another embodiment of a frame hook and an articulating lift plate assembly.

FIG. 62d is a plan view of a removable frame with another embodiment of a frame hook and an articulating lift plate assembly.

FIG. 63 is a plan view of another embodiment of a wheeled container with a pin, a receiver coupling system, and a lower frame receiver.

FIG. 63a is a plan view of another embodiment of a removable frame with a frame receiver, an articulating lift plate assembly, and a frame pin.

FIG. 64 is a plan view of another embodiment of a wheeled container with a frame pin.

FIG. 64a is a plan view of another embodiment of a removable frame with a frame receiver, a coupling pin, an articulating lift plate assembly and mounting block.

FIG. 64b is a plan view of an upper region of a removable frame with a coupling pin and a frame receiver.

FIG. 64c is a plan view of an upper region of another embodiment of a removable frame with a frame hook, a frame receiver, and a coupling pin.

FIG. 65 is a plan view of a removable frame coupling system for modular wheeled containers with dissimilar horizontal coupling bars.

FIG. 66 is a perspective view of a removable frame coupling system for modular wheeled containers with dissimilar horizontal coupling bars.

FIG. 67 is a perspective view of a modular wheeled container with a removable liner and supplemental coupling pins.

FIG. 68 is a perspective view of a flexible container with a coupling receiver.

FIG. 69 is a perspective view of a pin and receiver coupling system and supplemental coupling pins coupling flexible containers with a modular wheeled container.

FIG. 70 is a perspective view of a modular wheeled container with an articulating lift plate assembly, a mounting block, a cavity insert, and a handle extension.

FIG. 70a is a perspective view of a handle extension.

FIG. 71 is a perspective view of a lower region of a modular wheeled container with a mounting block and a frame pin.

FIG. 72 is a perspective view of a modular wheeled container with a vertical bumper.

FIG. 73 is a perspective view of a modular wheeled container with another embodiment of a vertical bumper.

FIG. 74 is a top view of a modular wheeled container with an articulating lift plate assembly.

FIG. 75 is a top view of modular wheeled container with another embodiment of an articulating lift plate assembly.

FIG. 76 is a perspective view of a modular wheeled container with another embodiment of an articulating lift plate assembly.

FIG. 77 is a top view of a modular wheeled container with horizontal bumper.

FIG. 78 is a perspective view of a modular wheeled container with a horizontal bumper.

FIG. 79 is a plan view of an articulating coupling pin.

FIG. 80 is a perspective view of a modular lifting container with a handle extension coupled to a similar modular lifting container fitted with a removable frame with a lift plate assembly.

### DETAILED DESCRIPTION OF THE INVENTION

General Overview:

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

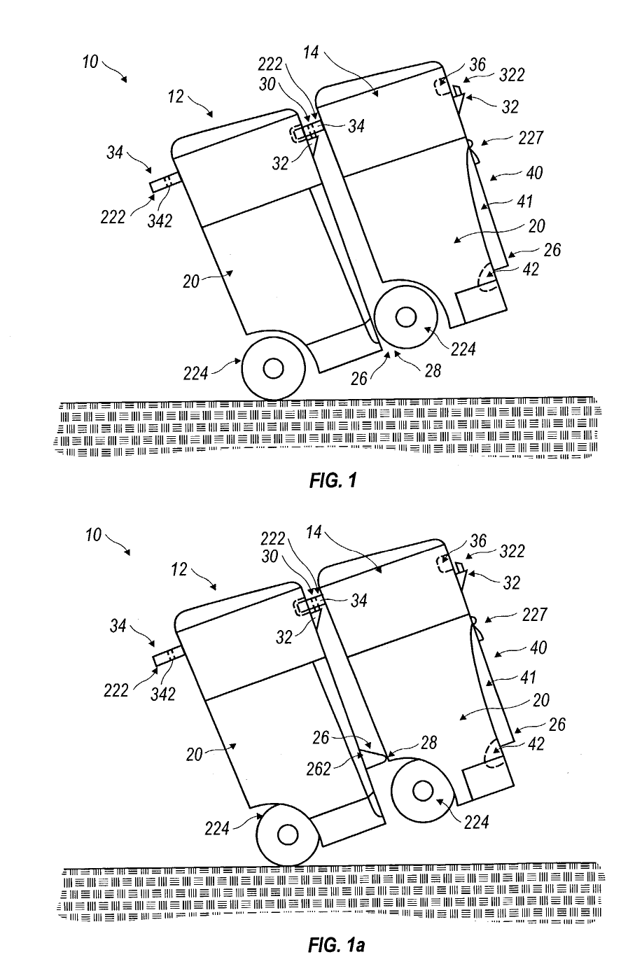

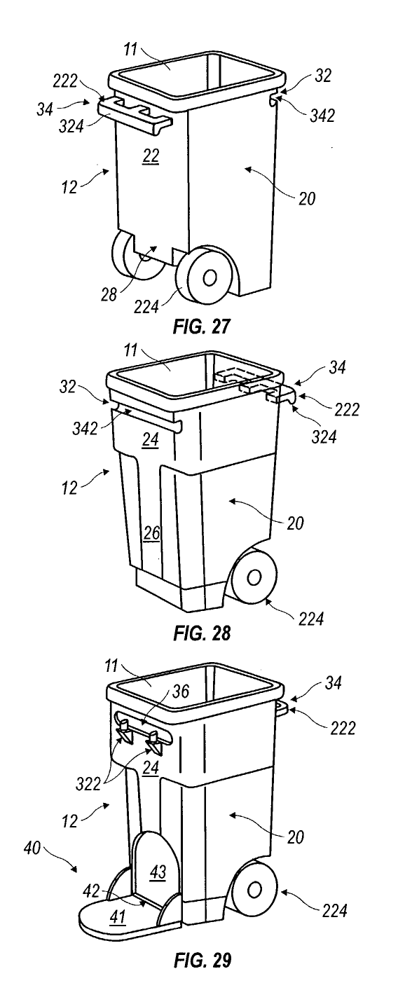

The present invention is directed toward a container coupling system 10 that releaseably couples a modular lifting container 12 to at least one carried container 14 (See FIGS. 1, 1a, 15, 30 33, 34, 35, 66, 69 and 80). A modular lifting container 12 includes a top opening 11, an outer wall 20, a maneuvering handle 222, a set of wheels 224, a bearing region 26, and a first coupling portion 32. An outer wall 20 extends through both a handling side 22 and a loading side 24 to form a modular lifting container 12 and a top opening 11 (See FIGS. 27 and 28).

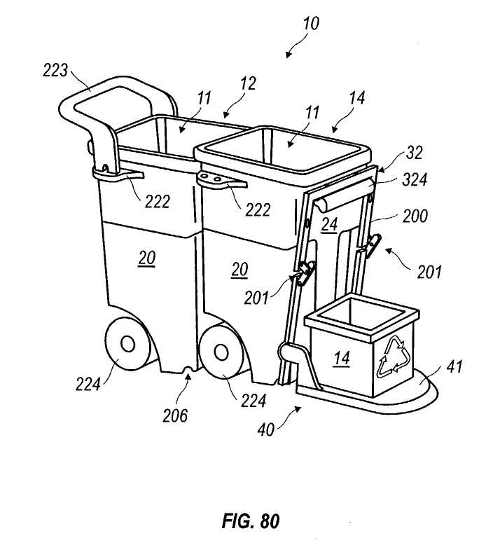

A maneuvering handle 222 is configured to be gripped by a user to tilt, maneuver or guide the movement of a modular lifting container 12 and any associated lifted load. A maneuvering handle 222 is configured to run generally parallel to an outer wall 20 of a modular lifting container 12. In a preferred embodiment, a maneuvering handle 222 is positioned on or adjacent to a handling side 22 of a modular lifting container 12 to guide the movement of a modular lifting container 12 (See FIGS. 27, 31, 32, 73 and 80). In another embodiment, at least two maneuvering handles 222 are positioned opposite each other on an outer wall 20 located between a handling side 22 and a loading side 24 (See FIG. 80). In such a configuration, a handle extension 223 is removably fixed to at least two opposing maneuvering handles 222 to allow a user to guide, handle, and tilt a lifting container 12. A maneuvering handle 222 can be fixed to an outer wall 20 in such a manner that it is fixed in one position (FIG. 27) or articulates (FIG. 31) with respect to an outer wall 20.

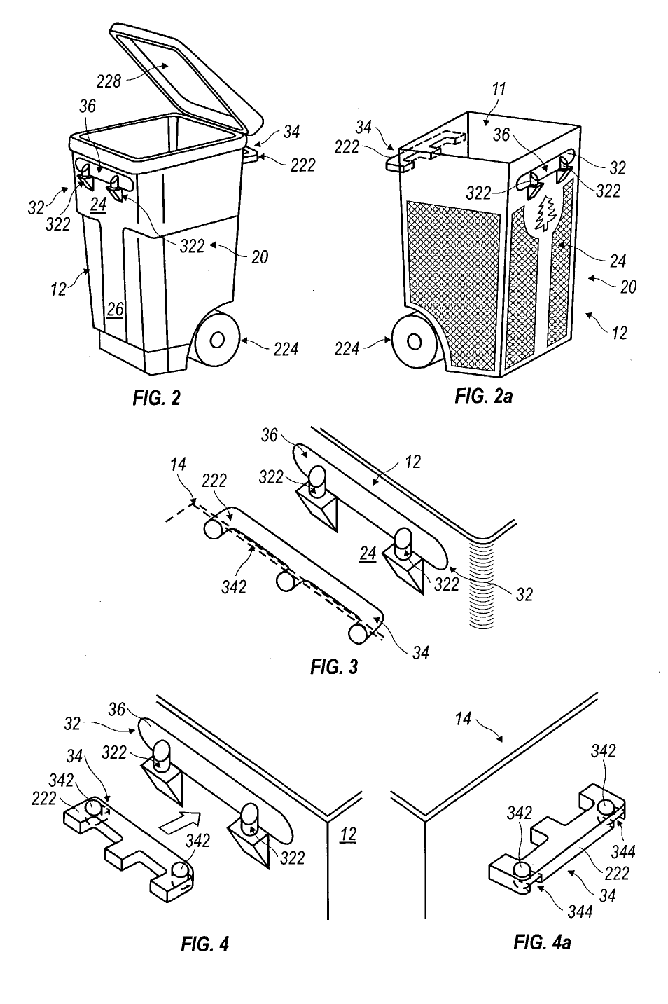

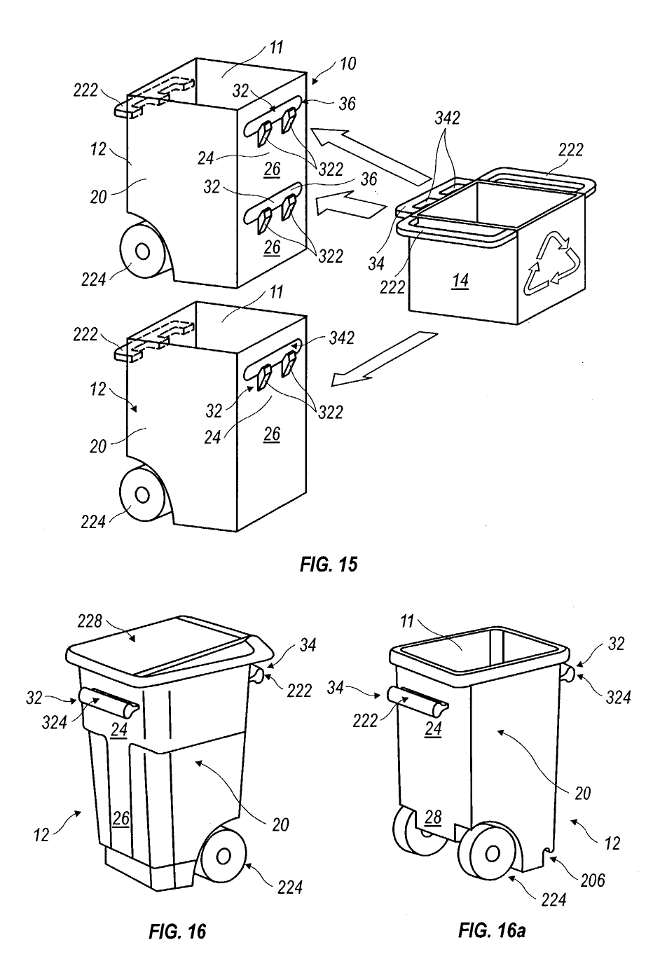

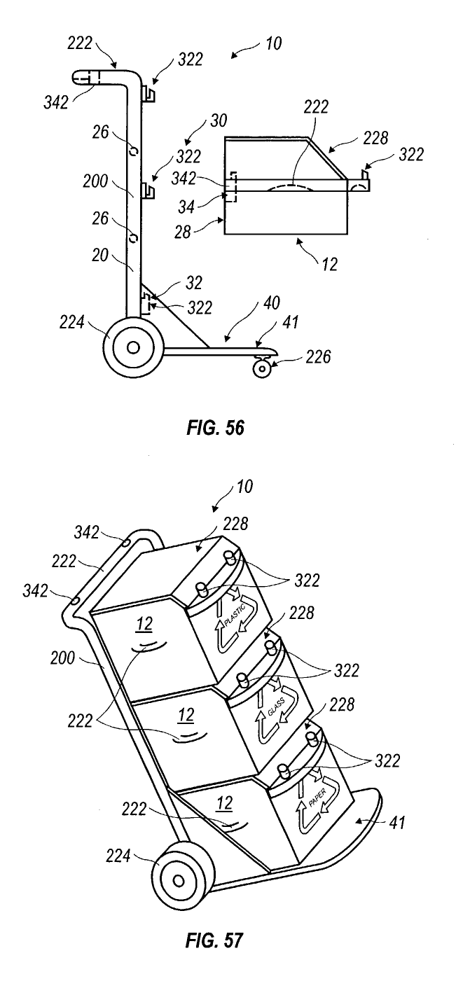

It is contemplated that a first coupling portion 32 of a coupling assembly 30 is located at an upper region of an outer wall 20 on a loading side 24 of a modular lifting container 12 (See FIGS. 2, 2a, 16, 16a, and 28). In a preferred embodiment, a first coupling portion 32 and a maneuvering handle 222 are positioned opposite each other on an outer wall 20 at substantially the same elevation on a modular lifting container 12 (See FIG. 1). In another embodiment, a first coupling portion 32 and a maneuvering handle 222 are at different elevations opposite each other on an outer wall 20 of a lifting container 12 (See FIGS. 15 and 56). In another embodiment, at least two maneuvering handles 222 and a first coupling portion 32 are positioned on an outer wall 20 perpendicular to each other (See FIG. 80). In yet another embodiment, a handle 22 is fixed to an outer wall 20 and extends about a substantial portion of an outer wall 20 (not shown). In another embodiment, a handle 222 is fixed and extends around an outer wall 20 (not shown).

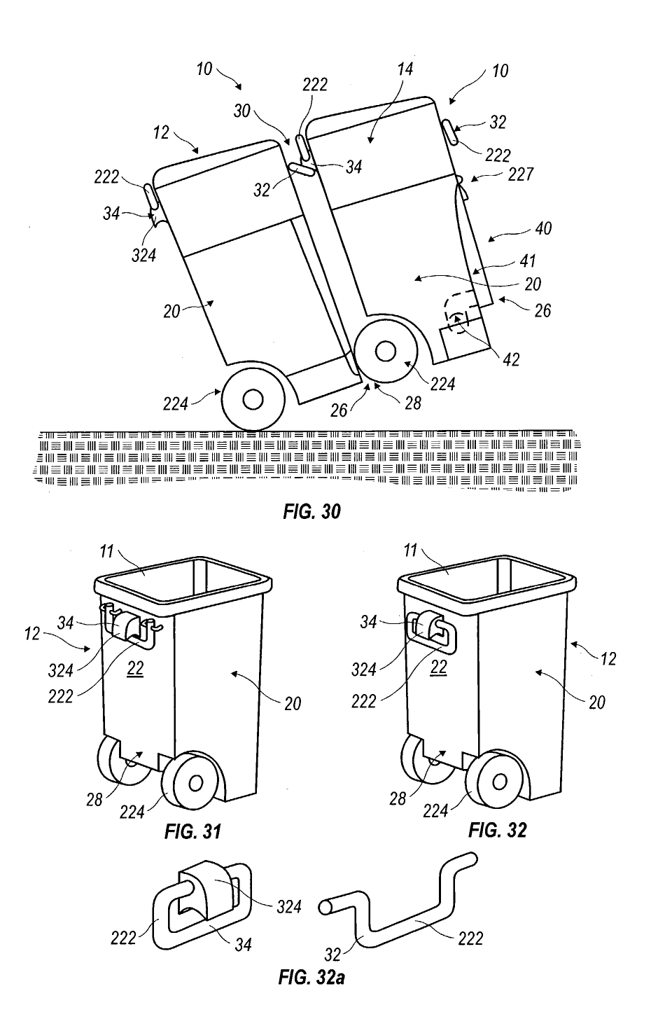

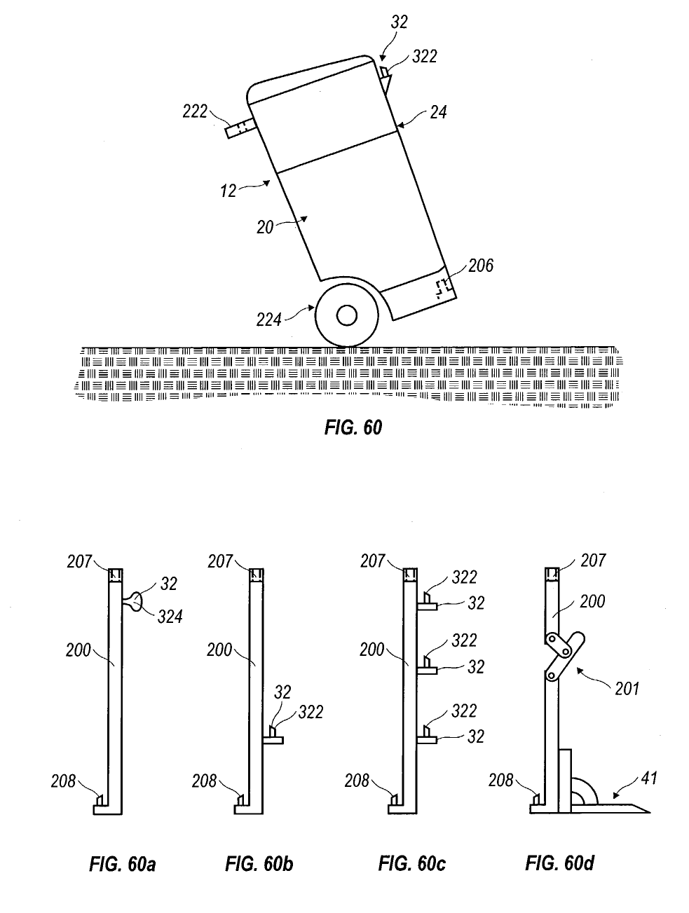

A first coupling portion 32 can be a pin 322 (FIG. 2), a horizontal coupling bar 324 (FIG. 16), a receiver 342 formed in an outer wall 20 (FIG. 28), and/or a handle 222 (FIGS. 30, 33, 34a, 34b, 35a through 35c, 36, 36a, and 37 through 40). As shown in FIGS. 2, 16, and 28, first coupling portion 32 is fixed to (or in the case of a receiver 342, formed in) an outer wall 20 on a loading side 24 of a modular lifting container 12. As shown in FIGS. 30, 33, 34a, 34b, 35a through 35c, 36, 36a and 37 through 40, a first coupling portion 32 is a handle 222 fixed (hinged or otherwise) to an outer wall 20 on a loading side 24 of a modular lifting container 12. FIGS. 60a through 60c, 61a, 62b, 64a through 64c illustrate a first coupling portion 32 which is removably fixed to a loading side 24 of a modular lifting container 12 by a removable frame 200.

Each modular lifting container 12 has a bearing region 26 located on a loading side 24, below a first coupling portion 32 (See FIGS. 2 and 15). A loading side 24 of a modular lifting container 12 may have multiple bearing regions 26 (See FIG. 15). A bearing region 26 is configured to at least partially support a modular carried container 14 (See FIGS. 1 and 15). A bearing region 26 can be located on an outer wall 20 (See FIG. 1) or a distal region of a bumper 262 fixed to an outer wall 20 (See FIGS. 1a and 72). A bearing region 26 can be flat, arcuate or any required shape to match a corresponding outer wall 20 of a modular carried container 14 (See FIG. 78).

A set of wheels 224 are located at a lower region of a handling side 22 of a modular lifting container 12 (See FIG. 27). A set of wheels 224 can extend beyond a periphery of an outer wall 20 (See FIG. 1) or be tucked within a periphery of an outer wall 20 (See FIG. 1a).

A preferred embodiment tucks a set of wheels 224 within a periphery of an outer wall 20 so that similarly configured modular lifting containers 12 can be stacked within each. In another embodiment, a set of wheels 224 are removable fixed to a modular lifting container 12 by a frame 200 (See FIGS. 56 and 57).

A carried container 14 includes an outer surface 20, a second coupling portion 34 and a contact region 28 below a second coupling portion 34 (See FIGS. 1, 15 and 68). A carried container 14 can be wheeled (See FIGS. 1 and 80) or not (See FIGS. 15, 68 and 80).

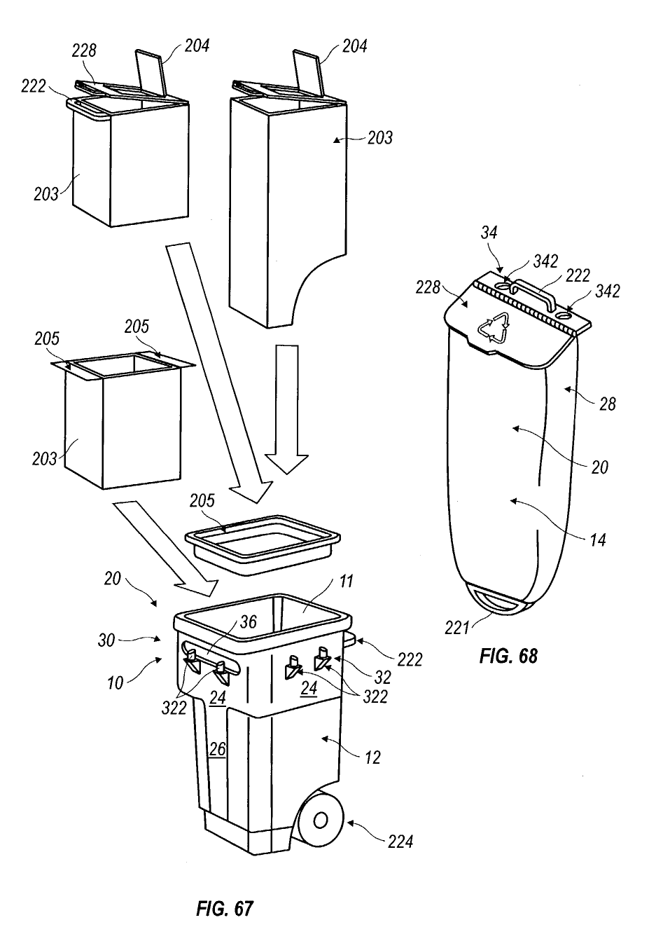

Furthermore a carried container 14 can have a rigid outer wall 20 (See FIGS. 1 and 80) or a flexible outer surface 20 (See FIG. 68).

In a preferred embodiment, as shown in FIGS. 1, 1a, 2, 2a, 16, 16a, 27, 28, 29, 30, 33, 35 and 80, a carried container 14 includes a first coupling portion 32, a second coupling portion 34, and a set of wheels 224. In one configuration of such an embodiment, a first coupling portion 32 and a second coupling portion 34 are both located at an upper region of an outer surface 20 and a set of wheels 224 are located at a lower region of outer surface 20 diagonal to a first coupling portion 32 and substantially directly below a second coupling portion. In another configuration of such an embodiment, second coupling portion 34 is integral with a handle 222 fixed to an outer wall 20 (See FIGS. 1, 1a, 2, 2a, 3, 4, 4a, 29, 33, 34, and 35). In another configuration of such an embodiment, a carried container 14, further includes at least two maneuvering handles 222 positioned at an upper region of an outer surface 20 opposite of each other and perpendicular to a first coupling portion 32 (See FIG. 80). Such maneuvering handles 222 can be further configured to releaseably engage a handle extension 223 (See FIG. 80). Such embodiments of a carried container 14 with handles 222 are capable of being tilted, handled and maneuvered by itself; with an adjacent load (like another carried container 14), or as an intermediary carried container 14 between a lifting container 12 and another carried container 14 (See FIGS. 1 and 80).

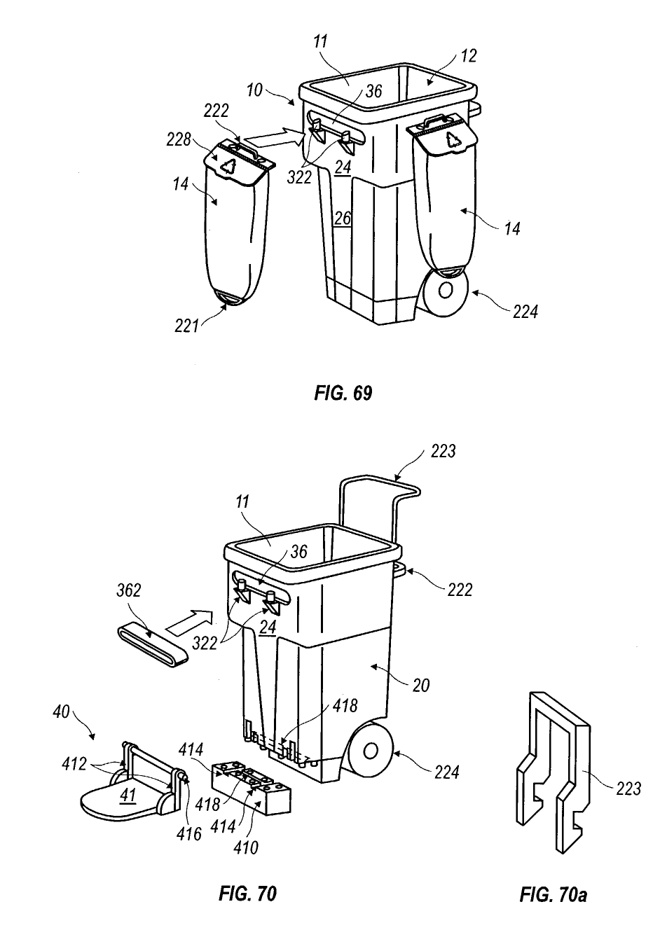

A carried container 14 may further include a carrying handle 222 fixed at an upper region of an outer surface 20 and configured to allow a user to pickup or handle directly a carried container 14. As described above, a handle 222 may be integral with a second coupling portion 32 (See FIG. 3) or be separate and apart from a second coupling portion 32 (See FIGS. 56 and 80). In one embodiment, a carrying handle 222 is configured to run generally parallel to an outer surface 20 of a carried container 14 (See FIGS. 15, 31, 32 and 80). In another embodiment, carrying handle 222 is fixed at an upper region of a carried container 14 adjacent to an opening 11 (See FIG. 68). An optional handle 221 can be fixed to a lower region of carried container 14 to assist a user in upending a carried container 14 (See FIGS. 68 and 69). It is further contemplated that a carrying handle 222 can be fixed to an outer wall 20 in such a manner that it is fixed in position (FIG. 15) or articulates with respect to an outer wall 20 (FIG. 31).

A second coupling portion 34 is fixed to an upper portion of an outer surface 20, above a contact region 28 of a carried container 14 (See FIG. 15). Contact region 28 can be located on an outer surface 20 (See FIGS. 1a and 16) or on a set of wheels 224 attached to a carried container 14 (See FIG. 1). A second coupling portion 34 is positioned at an elevation on a carried container 14 to allow releaseable engagement with a corresponding first coupling portion 32 with minimal alignment effort on behalf of a user.

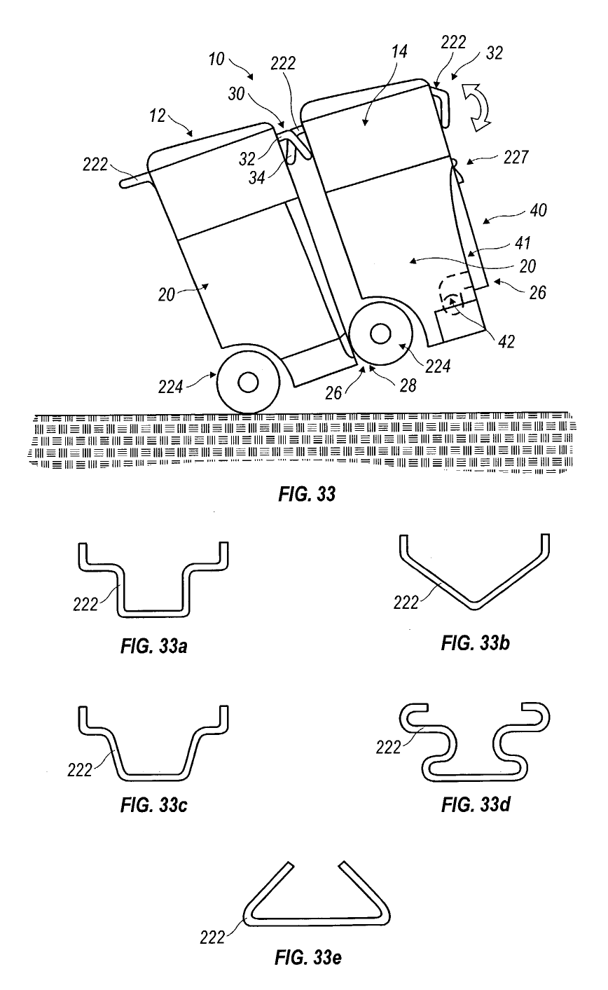

A second coupling portion 34 can be a receiver formed in a handle 222 (FIGS. 3, 4, 4a, 36 and 36a), a receiver 342 formed a outer surface 20 (FIG. 56), a coupling bar 324 (FIGS. 16, 16a and 31), a coupling bar 324 integrated into a handle 222 (FIGS. 27, 32 and 38), and/or a handle 222 (FIGS. 33 through 33e, 34, 34b, and 35 through 35c).

A coupling assembly 30 is made up of at least the following four elements, namely a first coupling portion 32, a second coupling portion 34, a bearing region 26 and a contact region 28 (See FIGS. 1, 1a, 30, 33, 34, 35, 56, and 66). A coupling assembly 30 couples a lifting container 12 with a carried container 14 by releaseably engaging a first coupling portion 32 with a corresponding second coupling portion 34.

As a lifting container 12 is tilted off a vertical axis onto a set of wheels 224, preferably by a maneuvering handle 222, a first coupling portion 32 lifts against and supports a second coupling portion 34 to urge a carried container 14 to tilt in a similar fashion as a lifting container 12. While at or near the same time as a lifting container 12 is tilted off a vertical axis, a contact region 28 of a carried container 14 engages and is provided support by a bearing region 26 to lift a carried container 12 off the ground. The distance between a coupling assembly 30 and an adjacent outer walls/surfaces 20 of modular containers 12 and 14 affects the distance between containers 12 and 14. Likewise, the distance between the coupling assembly 30 and adjacent outer walls/surfaces 20 of modular containers 12 and 14 affects the amount of tilt required to cause a carried container 14 to tilt in a similar fashion. If containers 12 and 14 are closer to each other, then a lesser amount of tilting a lifting container 12 will be required to cause a similar tilt to and lifting of a carrier container 14. Similarly, the distance between a contact region 28 and a bearing region 26 affects the amount of tilt required to cause a carried container 14 to tilt in a similar fashion. If a contact region 28 and a bearing region 26 are configured to make contact as soon as a lifting container 12 is tilted off vertical, then a lesser amount of tilting a lifting container 12 will be required to cause a similar tilt to and lifting of a carried container 14.

In one embodiment, coupling of first coupling portion 32 with second coupling portion 34 is located adjacent to an outer wall 20 on a loading side 24 of a lifting container 12 (See FIGS. 6, 8 and 12). In a preferred embodiment, coupling of a first coupling portion 32 with a second coupling portion 34 is located inside a cavity or port 36 formed in outer wall 20 on a loading side 24 of a lifting container 12 (See FIG. 10). In another preferred embodiment, coupling assembly 30 (which includes first coupling portion 32, second coupling portion 34, bearing region 26, and contact region 28) is configured to couple and maintain an equal or nearly equal separation gap between outer walls/surfaces 20 of a lifting container 12 and a carried container 14, thereby facilitating coupling, tilting and lifting of modular containers 12 and 14 in a parallel or nearly parallel orientation for rolling on a set of wheels 224 of modular lifting container 12.

To encourage coupling of containers 12,14, a bumper 262 is fixed to either a handling side 22 or a loading side 24 of a container 12,14 (See FIGS. 1a, 72, 73, 77 and 78). As described above a bearing region 26 can be located at an end region distal to outer wall 20. In a preferred embodiment, a bumper 262 is fixed vertically to an outer wall 20 of a container 12, 14. In another embodiment, a bumper 262 is horizontally fixed to an outer wall of a container 12, 14. In a vertical orientation, at least two bumpers 262 further encourage proper alignment between a first coupling portion 32 and a second coupling portion 34 particularly if the separation distance between the bumpers 262 is slightly greater than the overall width of a corresponding first or second coupling portion 34. For example, if two vertical bumpers 262 are fixed adjacent to a first coupling portion 32 (as depicted in FIG. 72) and with a separation slightly greater than the width of a corresponding second coupling portion 34, then the two vertical bumpers 262 will act as a guide to properly align the coupling portions 32,34 as they approach each other. While FIGS. 72 and 73 depict bumpers 262 which run a substantially height of a container 12,14, shorter bumper 262 lengths are contemplated.

As depicted in FIGS. 2, 2a, 16, 16a, 27, 28, 29, 31, 32, 39, 40, an outer wall 20 forms a container 12 and/or 14 and a top opening 11. Each modular container 12 and/or 14 has a bottom (not shown). Outer wall 20 has a handling side 22 opposite from a loading side24 (See FIGS. 27 and 28). A set of wheels 224 are fixed at a lower region of a handling side 22 (See FIG. 27). A handle 222 is fixed at an upper region of an outer wall 20 above a set of wheels 224 (See FIGS. 27 and 80). Each modular container 12 and/or 14 further includes a coupling assembly 30 made up of a first coupling portion 32, a second coupling portion 34, a contact region 28 and a bearing region 26. First coupling portion 32 is positioned at a loading side 24 of a container 12 and/or 14. A second coupling portion 34 is located at a handling side 22 of a container 12 and/or 14. A contact region 28 is located below a second coupling portion 34 on a handling side 22 of a container 12 and/or 14. A bearing region 26 is located below a first coupling portion 32 at a loading side 24 of a container 12 and/or 14.

A first coupling portion 32 is configured to releaseably couple with a corresponding second coupling portion of an adjacent container 12 and/or 14. Similarly, a bearing region 26 of a container 12 and/or 14 is configured to support a corresponding contact region 28 of an adjacent container 12 and/or 14. The different embodiments of a first coupling portion 32, a second coupling portion 34, and a handle 222 described above are applicable to a modular container 12 and/or 14. Furthermore, a coupling assembly 30 of a modular container 12 and/or 14 operates the same as a coupling assembly 30 described above.

A container, modular, lifting or carried 12,14 may be constructed from materials, such as metal, formed plastic, composite materials, and a combination thereof which are suitable for tilting and lifting with an adjacent coupled load. The same choice of materials can be used to construct a coupling assembly 30, a handle 222 and a set of wheels 224. Wheels 224 can further be constructed out of rubber or plastic and may be solid or pneumatic. A container, modular, lifting or carried 12, 14 can be adapted to hold or let liquids pass through outer wall 20 (See FIGS. 2 and 2a). Furthermore a carried container 14 can be rigid (See FIG. 57) or flexible (See FIG. 68). In a preferred embodiment, a container, modular, lifting or carried 12, 14 is constructed from plastic suitable for handling household and light industry refuse, recyclable materials, and/or bulk material.

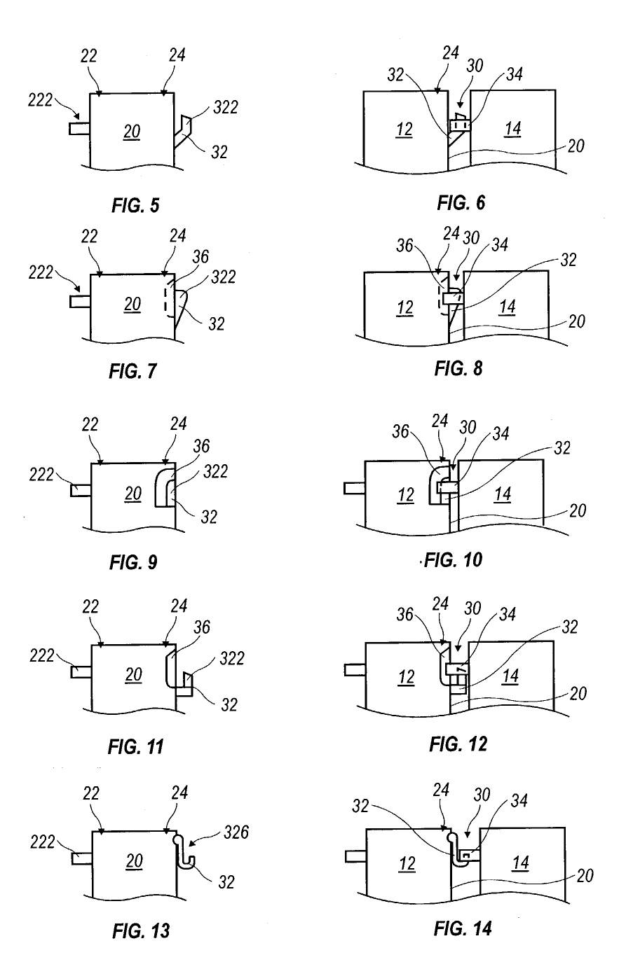

PIN AND RECEIVER: FIGS. 1 through 15 depict a container 12,14 in which a first coupling portion includes a pin 322 and a second coupling portion includes a receiver 342 formed in a handle 222. Pin 322 can be fixed to an outer wall 20 as shown in FIGS. 1 through 8, 11 and 12 or fixed to a hinged hook 326 attached to an outer wall 20 (See FIGS. 13 and 14).

Where a container 12,14 does not have a first and/or second coupling portion 32,34, it is contemplated that such a coupling portion 32 can be fixed to an outer wall 20 by a mounting block 38 to which a first or second coupling portion 32,34 is fixed by a insert 382 (See FIG. 79). Insert 382 is distal to a coupling portion 32,34. An aperture 386 is formed in a mounting block 38 which opens into a mount receiver 384. An insert 382 of a coupling portion 32,34 passes through an aperture 386 and securingly fits into a mount receiver 384. An insert 382 and a corresponding aperture 386 and mount receiver 384 are configured to prevent an insert 382 from disengaging from a mount receiver 384 when a load is applied to a coupling portion 32.

In one embodiment, a mount receiver 384 is a channel with a rectangular cross section which restricts freedom of movement of an insert 382 to only slide along a major axis of a mount receiver 384. In another embodiment, a mount receiver 384 has a polygonal cross section which allows an insert 382 with a corresponding polygonal cross section to be selectively positioned in a mount receiver 384. Like a mount receiver 384 with a rectangular cross section, a mount receiver 384 with a polygonal cross section restricts freedom of movement of an insert 382 to only slide along a major axis of a mount receiver 384. As can be appreciated, the more sides to a polygonal cross section, the more positions to which an insert can be positioned. Yet another embodiment contemplates a mount receiver 384 as a channel with an arcuate cross section. Such a cross section allows a corresponding insert 382 to have two degrees of freedom, namely sliding along a major axis of a mount receiver 384 and rotation about a major axis limited by the width of an aperture 386. Finally, in a preferred embodiment, a mount receiver 384 has a spherical surface which allows a corresponding insert 382 to have at least three degrees of freedom, namely rotation about three major axis perpendicular to each other and limited by the width of aperture 386 (See FIG. 79). Furthermore, movement of a insert 382 (and its corresponding coupling portion 32,34) can be eliminated or at least limited through the placement of stops 388 (not shown) positioned between a mount receiver 382 and an insert 384. Use of a mounting block 38 as described above allows a coupling portion 32,34 to be fixed to an outer wall 20 without much concern for perfect positioning and alignment. In other words, such an embodiment, compensates for improper positioning and alignment of a coupling portion 32,34 fixed to a container 12, 14.

FIGS. 1 through 4, 7, 8, 11 and 12 depict a modular container 11 in which a coupling assembly 30 further includes a cavity, port or aperture 36 formed in an outer wall 20 adjacent to a pin 322. Cavity, port or aperture 36 is adapted to receive a portion of a handle 222 and thereby allow a pin 322 to couple with a corresponding receiver 324. In a preferred embodiment, a pin 322 is located inside a cavity 36 (See FIGS. 9 and 10). In another embodiment, port 36 is fitted with a removable insert 362 (See FIG. 70).

Pin 322 can have a circular cross section (See FIGS. 2 through 4) or a polygonal cross section (not shown). In a preferred embodiment, a pin 322 has a beveled upper portion to facilitate coupling with a receiver 342. It is contemplated that at least one pin 322 is fixed to an outer wall 20 and in a preferred embodiment two pins 322 are fixed to an outer wall 20 (see FIGS. 1 through 4). In another embodiment, a number of pins 322 are fixed to a loading side 24 (See FIG. 15).

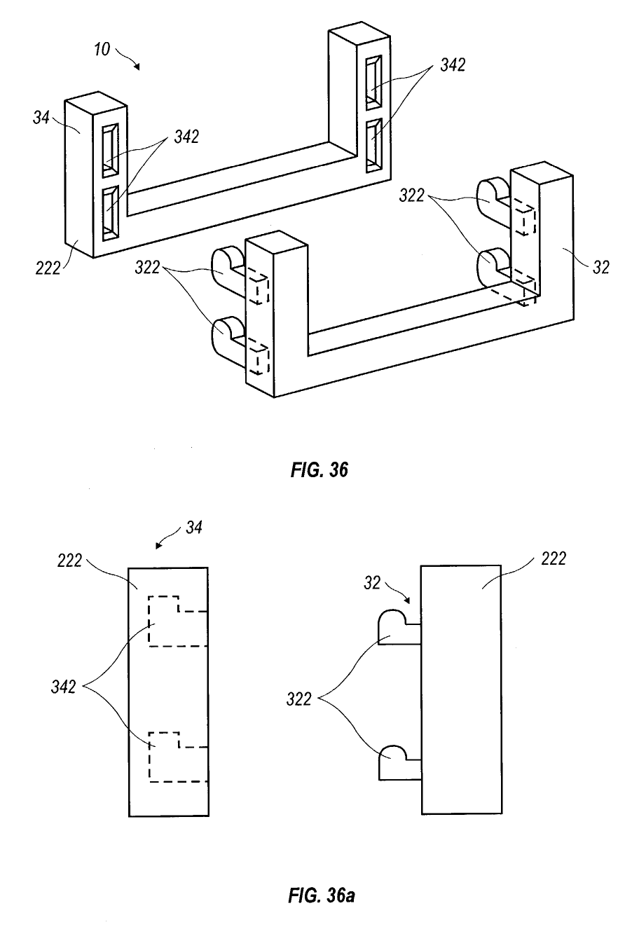

In one embodiment, a receiver 342 is formed in a handle 222 (See FIGS. 4 and 36). In another embodiment, a guide 344 is adjacent to a receiver 342 to guide and encourage alignment and coupling of a pin 322 with a receiver 342 (See FIGS. 4 through 6). In another embodiment, a receiver 342 is sufficiently wide and long to allow a user's hand to fit in (or through) and grasp a handle 222 (See FIGS. 2a and 3).

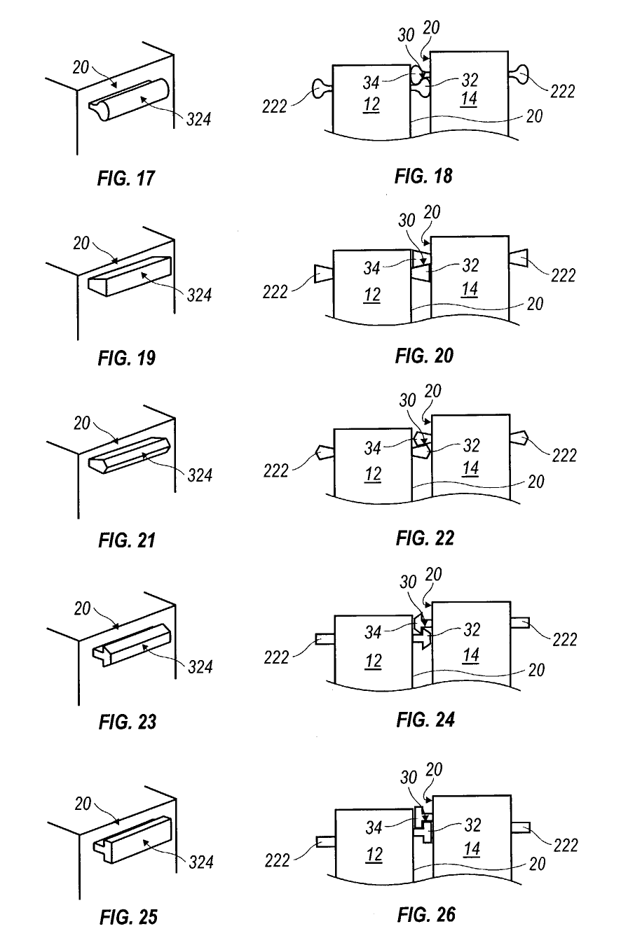

COUPLING BARS: FIGS. 16 through 26 depict containers 12,14 in which a first coupling portion 32 includes a first coupling bar 324, and a second coupling portion 34 includes a second coupling bar 324. Both coupling bars 324 are horizontally mounted to an outer wall/surface 20 of a container 12,14. Engagement of coupling bars 324 occurs when a first coupling bar 324 of a lifting container 12 engages a lower region of a second coupling bar 324 of a carried container 14. In one embodiment, a handle 222 is integral with a second coupling bar 324 (FIGS. 18, 20, and 22) and configured to allow a user to tilt, handle, or maneuver an uncoupled container or coupled containers 12, 14. Such a configuration allows similar wheeled modular containers 12,14 to be coupled with a set of wheels 224 positioned below or diagonal to a coupling assembly 30 (not shown). In another embodiment, a maneuvering handle 222 is opposite to a second coupling bar 324 (See FIGS. 24 and 26) which allows similar wheeled containers 12,14 to be coupled with a set of wheels 224 positioned diagonally to a coupling assembly 30 (not shown).

Where a coupling bar 324 is used, it is further contemplated that such a bar may be configured to allow a user to grasp the bar as a handle 222. In one embodiment, the cross section of a coupling bar 324 is such as to accommodate a user's grasp. Another embodiment has a coupling bar 324 configured with a receiver 342 to accommodate a user's grasp.

COUPLING BARS AND RECEIVER: FIGS. 27 and 28 depict a modular container 12 and/or 14 in which a second coupling portion 34 includes a horizontal coupling bar 324 integral with a maneuvering/carrying handle 222; and a first coupling portion 32 that includes a receiver 342 formed in an outer wall 20 of a loading side 24. Receiver 342 is configured to releaseably receive and hold a horizontal coupling bar 324.

COUPLING HANDLING BAR: FIGS. 30 through 32a depict a modular container 12 and/or 14 in which a coupling assembly 30 includes a pivotal coupling handle 222 (which is part of a first coupling portion 32) and a coupling bar 324 (which is a part of a second coupling portion 32). Coupling bar 324 is fixed to an outer surface 20 of a carried container 14 and further configured with a lower region adapted to releaseably engage a coupling handle 222 pivotally fixed to a lifting container 12 (See FIGS. 30 and 32a). Although not shown, coupling handle 222 can be pivotally fixed in a cavity 36 to reduce the gap between coupled containers 12 and 14. In one embodiment, a maneuvering handle 222 is pivotally fixed to an outer wall/surface 20 adjacent to a coupling bar 324 (See FIG. 31). In another embodiment, a maneuvering handle 222 is pivotally fixed to a coupling bar 324 (See FIG. 32).

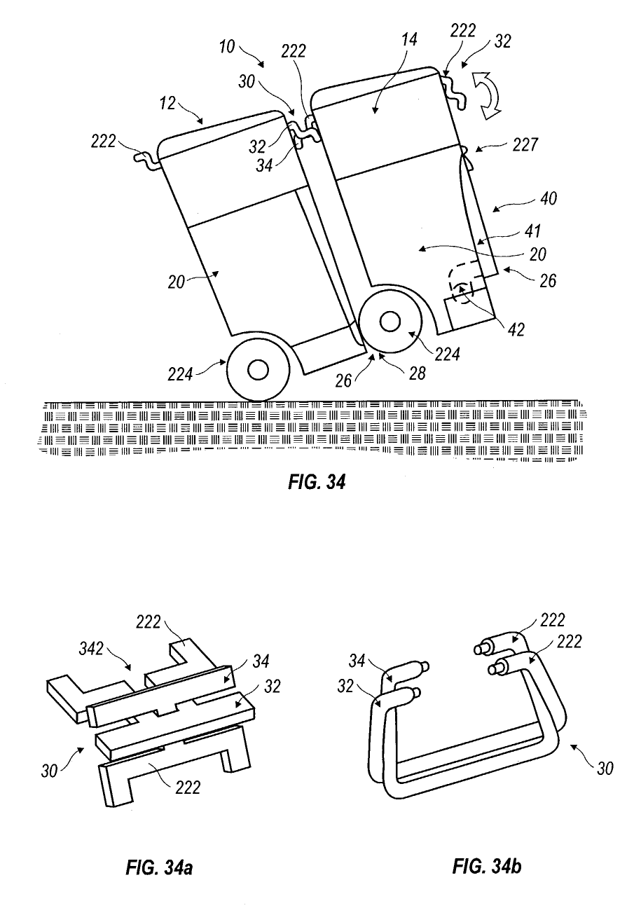

COUPLING HANDLES: FIGS. 33 through 34 and 34b illustrate a coupling assembly 30 in which handles 222 pivotally attached to an outer wall/surface 20 couple with a corresponding adjacent handle 222 of another modular container 12 and/or 14. In particular, FIGS. 33 through 33e, 34, and 34b depict a first coupling portion 32 which includes a first coupling handle 222 pivotally fixed to an outer wall 20 at a loading side 24 of a lifting container 12; and a second coupling portion 34 which includes a second coupling handle 222 pivotally fixed to an outer surface 20 above a contact region 28 of a carried container 12. A first coupling handle 222, as shown in FIGS. 33a through 33e, 34 and 34b are configured to releaseably engage a portion of a second coupling handle 222 of similar configuration. When a first coupling handle 222 and a second coupling handle 222 are engaged, the radius of the arc traveled by a distal region of a second coupling handle 222 must be of sufficient length to cause a second handle 222 to make contact with a loading side 24 of a lifting container 12 (See FIGS. 33 and 34). In one embodiment, coupling handles 222 have coplanar portions to facilitate coupling and further function as a latch 227 for a lid 228 (See FIG. 34).

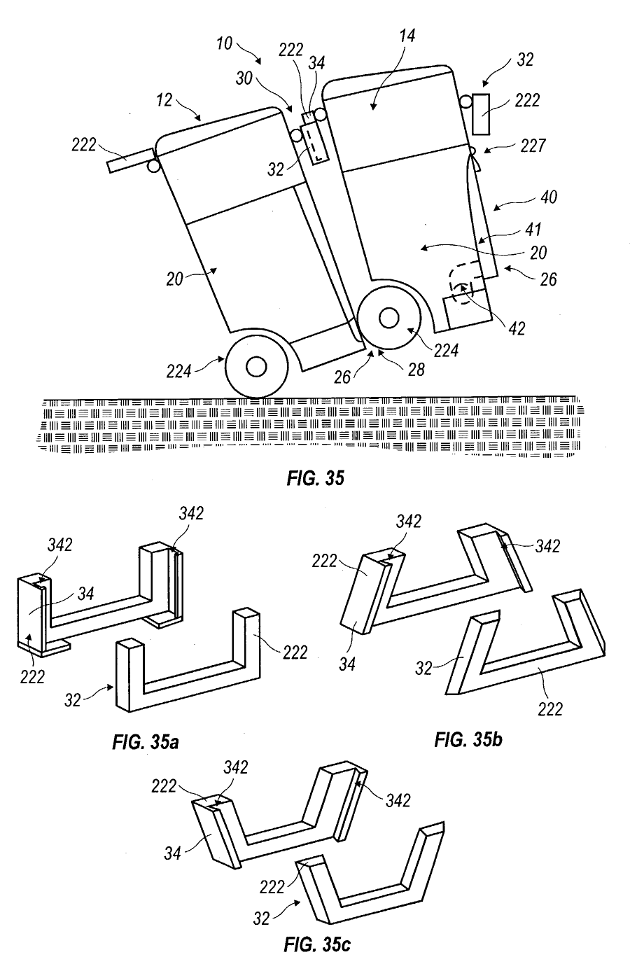

FIGS. 34a and 35 through 35c depict a first coupling portion 32 with a receiver 342 formed in a first coupling handle 222 pivotally fixed to an outer wall 20 of a lifting container 12; and a second coupling portion 34 with a second coupling handle 222 pivotally fixed to an outer surface 20 of a carried container 14. As shown in FIG. 34a, one embodiment of a coupling assembly 30 has a receiver 342 formed in a first coupling handle 222 to receive a portion of an adjacent second coupling handle 222. As shown in FIG. 34a, receiver 342 is configured to allow coupling at end regions of adjacent first and second coupling handles 222. Another embodiment of a receiver 342 formed in a first coupling handle 222 is depicted in FIGS. 35 through 35c. In such an embodiment, receiver 342 is configured as a channel positioned on a face of first coupling handle 222 so that adjacent first and second coupling handles 222 are coupled parallel to each other (See FIGS. 35 through 35c).

HANDLES WITH COUPLING PIN/RECEIVER: Another embodiment of coupling containers 12 and/or 14 to each other by handles 222 is depicted in FIGS. 36 and 36a. As shown in FIGS. 36 and 36a, first coupling portion 32 includes a first coupling handle 222 with at least one pin 322 projecting away from first coupling handle 222. A second coupling portion 34 includes a receiver 342 formed in a second coupling handle 222. A first coupling handle 222 is pivotally fixed to an outer wall 20 at a loading side 24 of a lifting container 12.

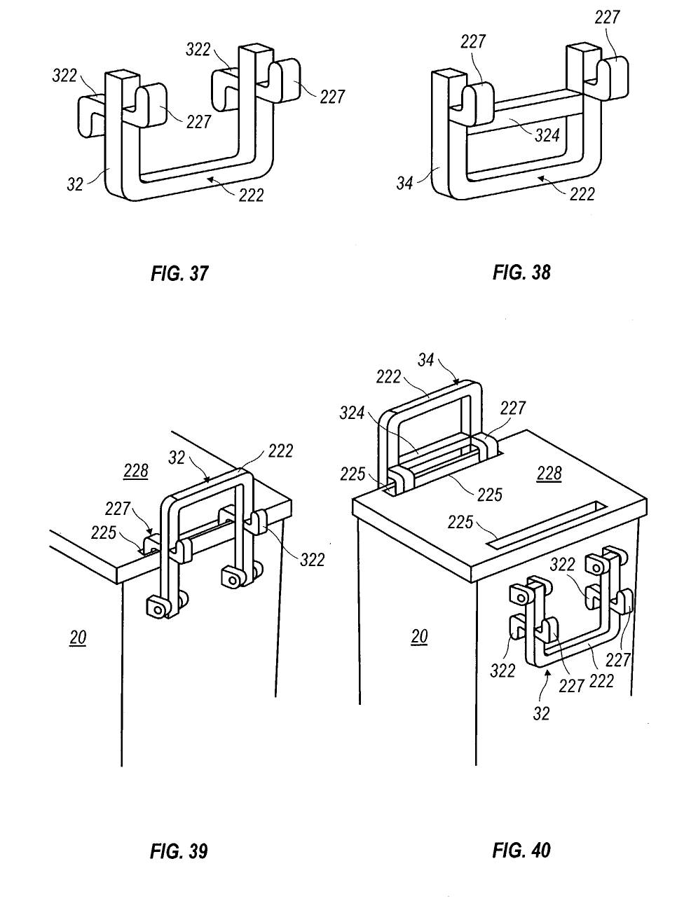

A second coupling handle 222 is pivotally fixed to an outer surface 20 of a carried container 14. Pin 322 is releaseably engaged by receiver 342. HANDLES WITH COUPLING PIN/COUPLING BAR: FIGS. 37 through 40 show a different embodiment of coupling handles 222. As shown in FIG. 37, a first coupling portion 32 includes a pin 322 positioned opposite a latch 227 on a first coupling handle 222 pivotally attached to a loading side 24 of a lifting container 12 (See FIG. 39). A second coupling portion 34 includes a coupling bar 324 fixed to a second coupling handle 222 pivotally attached to an outer surface 20 of a carried container (See FIG. 40). Coupling assembly 30 further includes a lid receiver 225 formed in a container lid 228. As first coupling handle 222 is raised up, latch 227 releaseably engages lid receiver 225 to keep lid 228 closed and further provide securement of first coupling handle 222 in an upward position for coupling to a carried container 14. At the same time first coupling handle 222 is raised up, a pin 322 comes into position to releaseably engage a second coupling handle 222. A coupling bar 324 of second coupling handle 222 is configured to releaseably engage a pin 322 on a first coupling handle 222 that is in an up position with a latch 227 engaging a container lid 228 (See FIG. 39). In a preferred embodiment, second coupling handle 222 is positioned in an up position before coupling bar 324 is engaged with a corresponding pin 322. An alternative embodiment of a second coupling handle 222 allows coupling of a first coupling handle 222 with a second coupling handle 222 in either an up or down position.

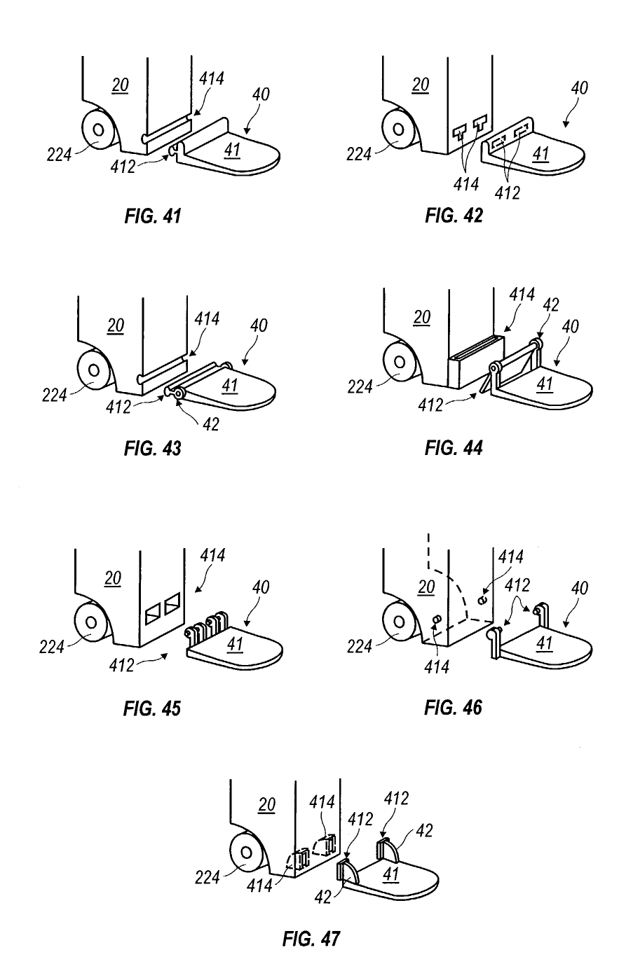

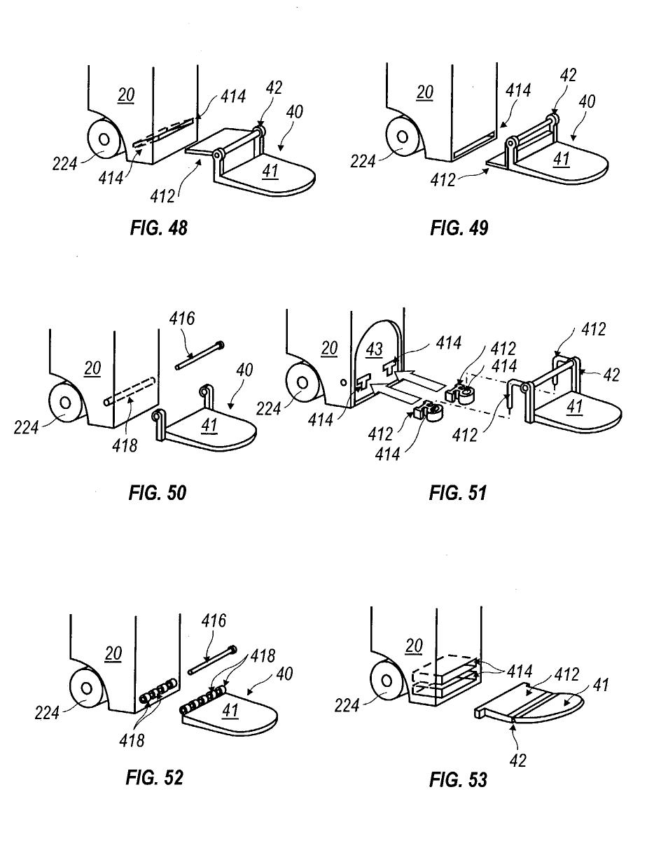

LIFT PLATE ASSEMBLY: Where a carried container 14 or a load does not posses a second coupling portion 34, a lifting container 12 can be configured with a lift plate assembly 40 (See FIGS. 29, 41 through 58, and 70). A lift plate assembly 40 includes a lift plate 41 that can be fixed in a load position (See FIGS. 41, 42 and 57) or articulate from a stored position to a load position (See FIGS. 29 and 53).

A lift plate assembly 40 can be permanently or removably fixed to a lifting container 12. A lift plate 41 can be removably fixed to a lifting container 14 by a variety of pin/plate 412 and receiver 414 arrangements (See FIGS. 41 through 49, 51 and 53). Likewise a lift plate 41 can be removably fixed to a lifting container 12 by a bolt 416 and bolt receiver 418 (See FIGS. 50, 52, 70 and 71).

It should be noted that where a receiver 414 is unable to be formed in an outer wall 20 during the manufacturing process, a bolt receiver 418 is formed in a block 410 and lower region of a container 12 as shown in FIGS. 70 and 71. In such an embodiment, a block 410 is fixed to a container 12 by rivets 411. In another embodiment, a block 410 is further adapted with a block receiver 413 configured to a receiver pin 208 for proper alignment of block 410 to a container 12, 14.

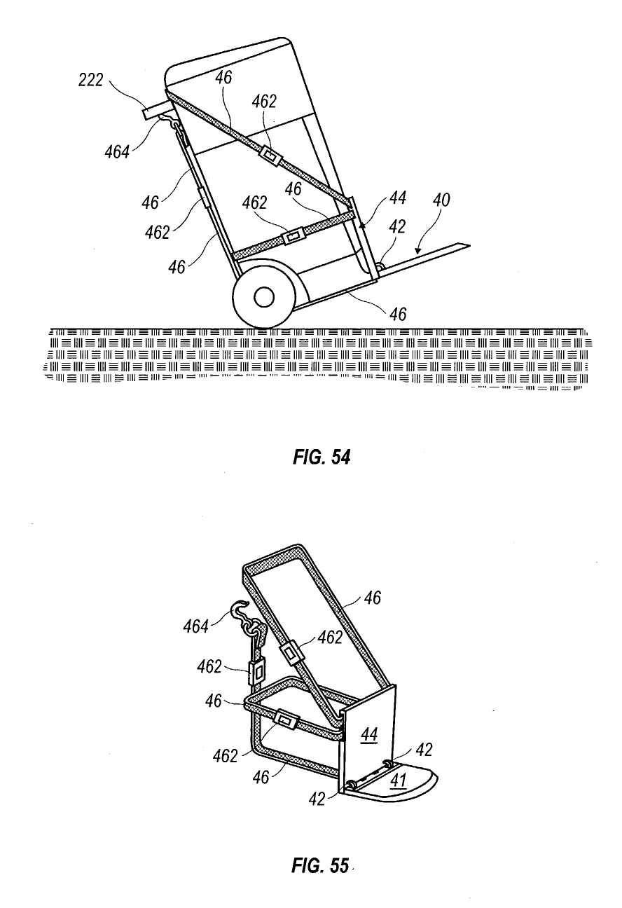

An alternative embodiment contemplates a lift plate assembly 40 to be removably fixed to a lifting container 12 by strapping 46 (See FIGS. 54 and 55). Where strapping 46 is used, securement and tensioning can be achieved by traditional means, such as buckles 462, tensioning buckles (not shown), hooks (464) or hook/loop fastening device (not shown).

An alternative embodiment, as shown in FIGS. 56 and 57, shows a lift plate assembly 40 fixed to a wheeled frame 200 which is removably fixed to a container 12,14. A further variation includes a castor 226 fixed to an end portion of a lift plate 41 (See FIG. 56).

Furthermore, a removable frame 200 can be fitted with a second coupling portion 34, such as a receiver 342 (See FIGS. 56 and 57).

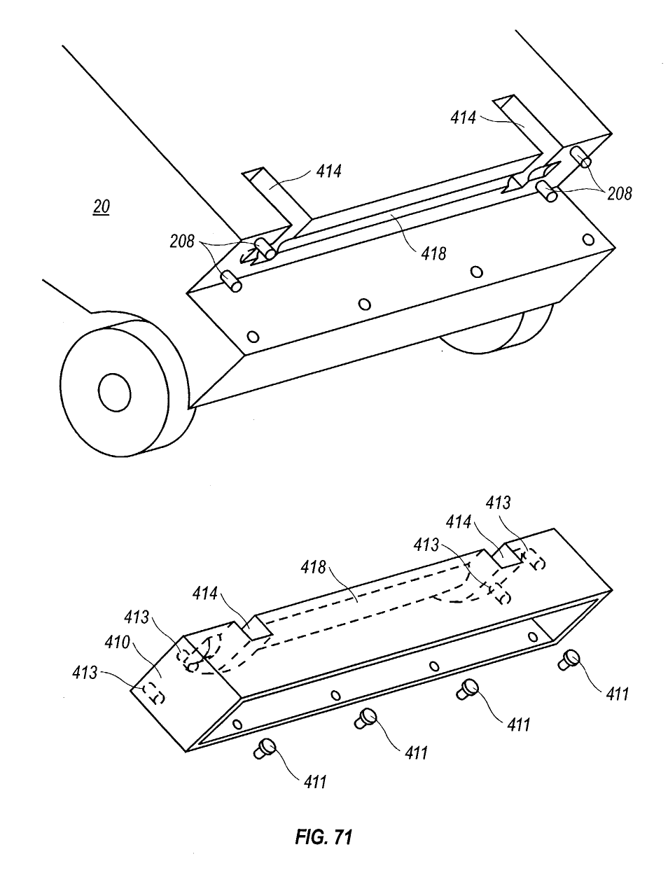

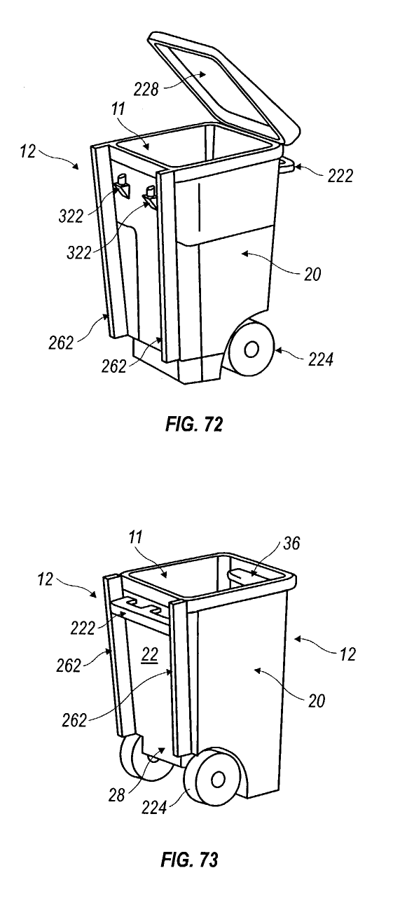

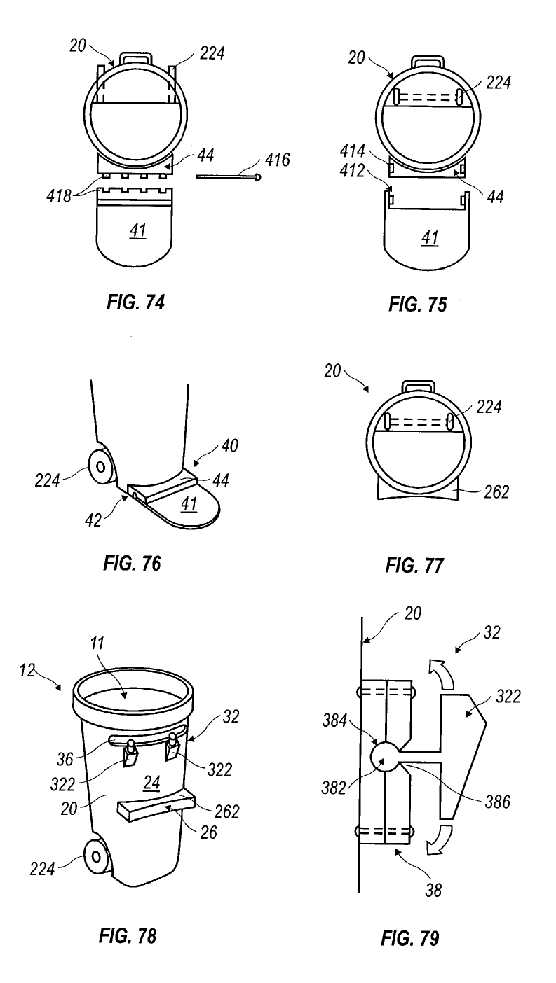

FIGS. 74 through 76 depict modifications by which a lift plate assembly 40 can be fixed to existing containers 12,14 which have wheels 228. Such a lift plate assembly 40 includes an adaptor 44 which is configured to fit against and be fixed to an outer wall 20 of a container 12,14. Such an adaptor 44 is attached to lift plate 41 by any one of the fixation variations described above. Fixation of an adaptor 44 to an outer wall 20 can be achieved through traditional fastening means, such as rivets, bolts, adhesives, and even strapping 46.

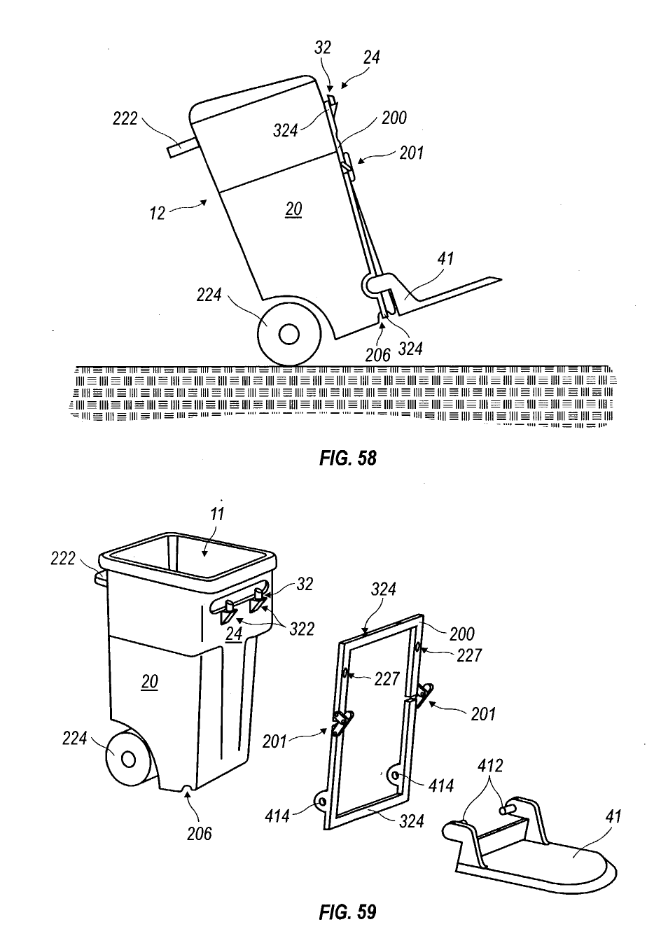

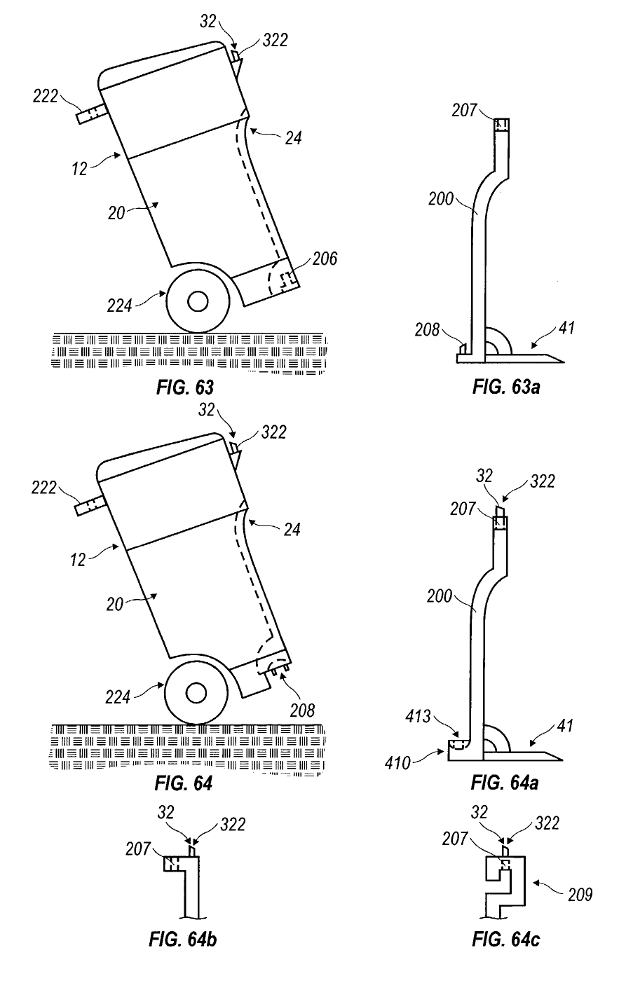

REMOVEABLE FRAME: FIGS. 58 through 64c depict a container 12 in which a frame 200 is removably fixed to a container 12 at an upper and lower region of a loading side 24. A frame 200 can be constructed to be generally rectangular in shape (See FIG. 59 and 80) or in the shape of “I” (FIG. 66) or “T” (not shown).

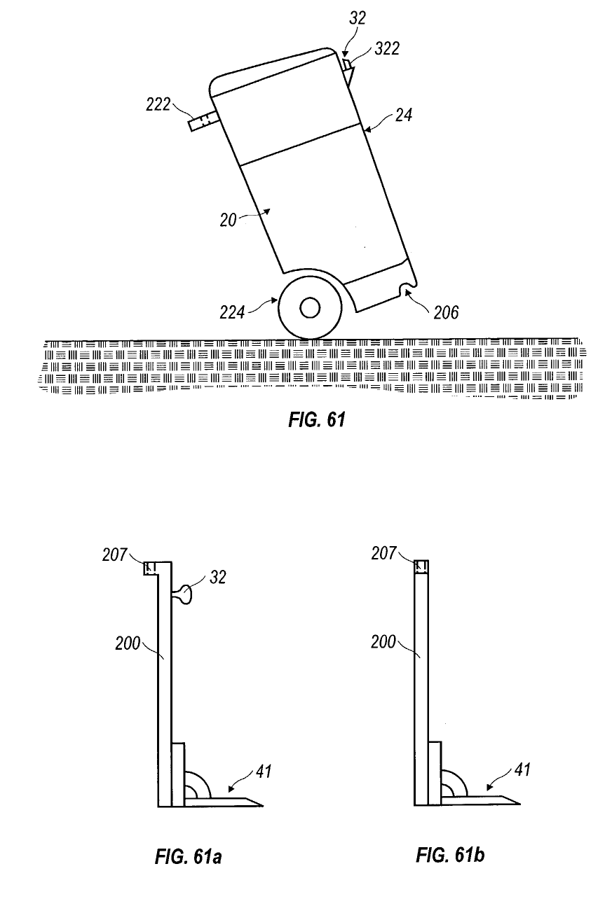

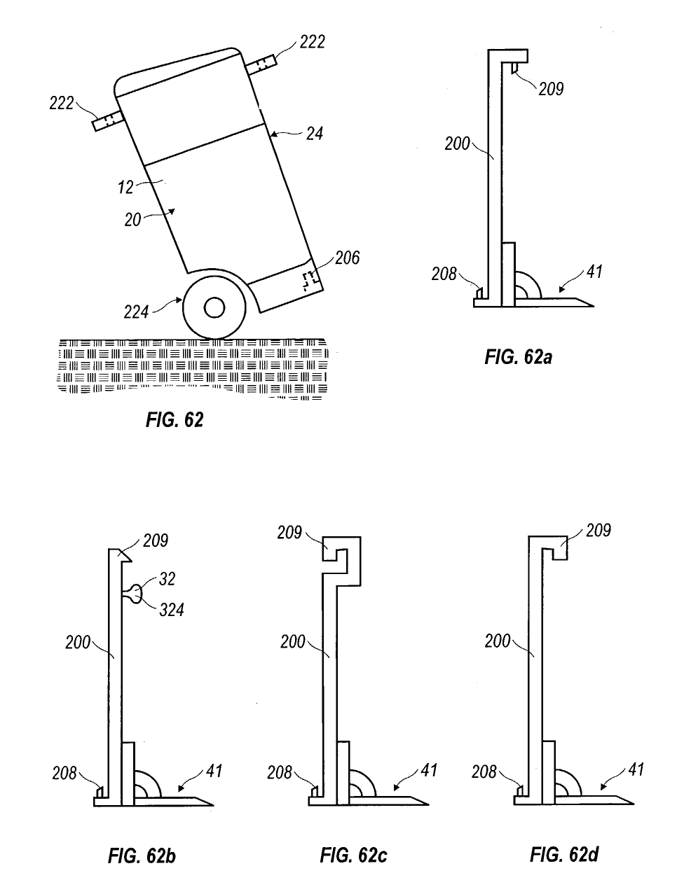

One embodiment of removable fixation of a frame 200 at an upper region includes an upper coupling bar 324 configured to engage a first coupling portion 32 of a container 12 (See FIGS. 58 and 59). Another embodiment includes an upper frame receiver 207 (formed in a removable frame 200) which is configured to engage a first coupling portion 32 of a container 12,14 (See FIGS. 60 through 60d, 61 through 61 b, and 63 through 64c). A further embodiment for removable fixation at an upper region includes an frame hook 209 fixed to an upper region of a frame 200, which is configured to engage a handle 222 or coupling bar 324 fixed to a loading side 24 on a container 12,14 (See FIGS. 62 through 62d).

A frame 200 can be removably fixed to at a lower region of a container 12 by a variety of means. One variation contemplates a frame 200 removable fixed by a lower coupling bar 324 configured to engage a lower frame receiver 206 of a container 11 (See FIGS. 61 through 61b). An alternative embodiment calls for a frame 200 to be removably fixed by a lower frame pin 208 configured to releaseably engage a lower frame receiver 206 of a container 12, 14 (See FIGS. 60 through 60d, 62 through 63a) Yet another embodiment contemplates a frame 200 to be removably fixed by a block receiver 410 configured to releaseably engage a frame pin 208 fixed to a lower region of a container 12 (See FIGS. 64 and 64a). It is contemplated that the above described upper and lower fixation embodiments can be used together to develop a wide variety of removable frame 200/container 12 configurations.

A frame 200 with a fixed length is removably fixed to a container by bowing it so that a portion of frame 200 just clears a first coupling portion 32, a frame pin 208 and/or a lower frame receiver 206. An alternative embodiment calls for a first coupling portion 32 to be constructed so that it flexes more in comparison to a frame 200 of fixed length. A preferred embodiment is a frame 200 with a variable length (See FIGS. 59, 60d and 80).

The length of a frame 200 can be varied by a locking cam 200 (See FIGS. 59, 60d and 80), a spring (not shown) or other means which would allow a frame 200 to expand to fit over/into upper and lower fixation regions of a container 12; and then shorten to cinch up against an upper region of an outer wall 20 and a lower frame receiver 206 or frame pin 208. In another embodiment, a frame 200 is segmented to allow proper mounting to a container 12,14. Securing a segmented frame 200 can be carried out by a locking cam 201 (See FIG. 80).

In another embodiment, a frame 200 can be removably fixed to a lower frame receiver 206 and a maneuvering handle 222 positioned diagonally to a lower frame receiver 206 (not shown). Yet another embodiment contemplates a frame 200 which is removably fixed to at least two coupling bars 324 fixed to a loading side 24 of a container 12, 14 (not shown).

A removable frame 200 can be constructed from the same material used in the construction of a container 12. It is further contemplated that a removable frame 200 can be constructed from rubber and composite materials able to withstand loads from a lift plate assembly 40 and/or a carried container 14.

Aside from how a frame 200 is removably attached to a container 12 or constructed, each frame can be configured as a base structure for a variety of coupling portions 32 or 34 and/or lift plate assemblies 40 (See FIGS. 58 through 64a and 80). As depicted in FIGS. 60b and 60c, a removable frame 200 can be fitted with a first coupling portion 32 (such as a pin 324) at elevations below (or even above) a first coupling portion 322. Such an arrangement is useful to allow a user to couple a carried container 14 at different elevations or even couple multiple carried containers 14 to a lifting container 12 that has only one first coupling portion 32 at an upper region of an outer wall 20.

As shown in FIGS. 60a, and 61a, a removable frame 200 can be fitted with a first coupling portion 32 that is different from a first coupling portion 32 fixed to an upper region of an outer wall of a lifting container 12. Such an arrangement allows coupling of containers 12,14 with incompatible fixed first and second coupling portions 32, 34. FIGS. 62 through 62c depict a removable frame 200 which can provide a container 12,14 with a first coupling portion 32 (such as a coupling bar 324 as shown in FIG. 62b) where none was originally fixed to an outer wall 20.

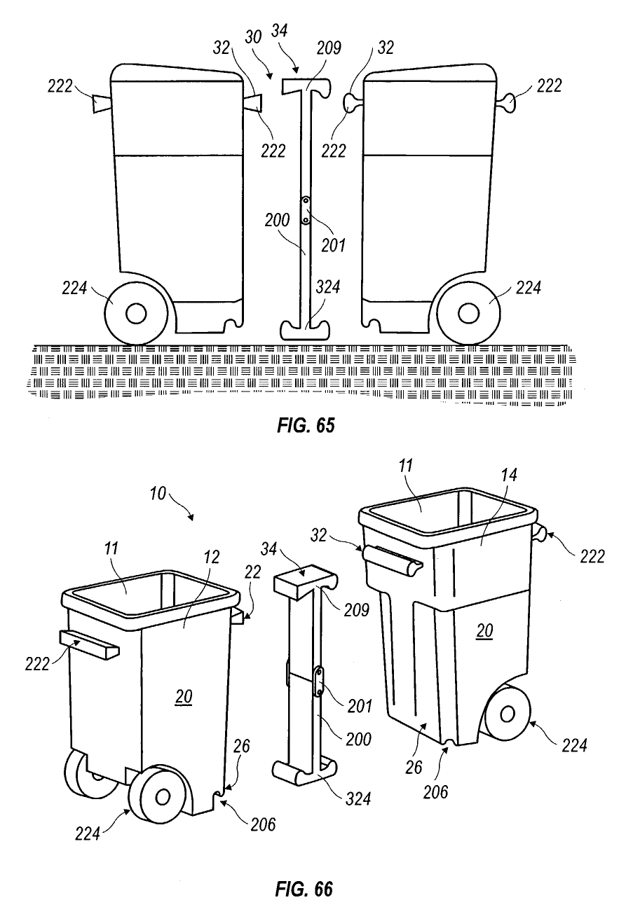

As shown in FIGS. 65 and 66, a coupling assembly 30 includes a removable frame 200 with frame hooks 209 at an upper region and configured to releaseably engage two different types of coupling portions 32 of adjacent containers 12. At a lower region of a frame 200, a frame bar 324 is configured to releaseably engage a lower frame receiver 206. Although not shown, a releaseable engagement of a lower region of a frame 200 to a container 12, can be accomplished as described above. As shown in FIGS. 65 and 66, an upper frame hook 209 is configured to releaseably engage the upper portion of two dissimilar coupling bars 324 of adjacent containers 12,14, thus making an upper frame hook as a second coupling portion 34. It is further contemplated, though not shown, that an upper frame hook 209 of a frame 200 can be configured to releaseably engage an upper portion of a first coupling portion 32 and a lower portion of an incompatible second coupling portion 34. Likewise, a lower frame hook 209 of a frame 200 can be configured to releaseably engage dissimilar lower frame receivers 206 and/or frame pins 208 (not shown). Securement of such a removeable frame to adjacent containers 12,14, can be accomplished as described above. A preferred embodiment is a can 201.

LINER: As shown in FIG. 67, a lifting container 12 is configured to receive through its top opening 11, a removable liner 203. A removable liner 203 can be constructed from the same materials as a container 12, 14, as described above. A liner 203 can have rigid or flexible walls that form an open end 11 opposite a bottom (not shown). A closeable lid 208 can be fitted over a top opening 11 of liner 203. Such a lid 208 can be configured with a swinging door 204. Furthermore, a handle 222 can be fixed to an upper region of a liner 203.

Releaseable fixation of a liner 203 to a lifting container 12 can be achieved by a liner mount 205. In one embodiment, a liner mount 205 is fixed to a liner 203 and is configured to engage a top opening 11 of a lifting container 12. In a preferred embodiment, a liner mount 205 is removably fixed between a liner 203 and a lifting container 12. The outer portion of a removable liner mount 205 is configured to engage a top opening 11 of a lifting container 12; and the inner portion of a removable liner mount 205 is configured to engage an open end 11 of a liner 203.

SUPPLEMENTAL COUPLING PINS: As depicted in FIGS. 67 and 69, a lifting container 12 can be fitted with a supplemental first coupling portion 32 fixed to an outer wall between handling side 22 and loading side 24. In a preferred embodiment, a supplemental first coupling portion 32 includes a pin 322 (See FIG. 67). A supplemental first coupling portion 32 is configured to releaseably couple with a carried container 14.

As depicted in FIG. 69, a preferred embodiment contemplates a supplemental first coupling portion 32 releaseably coupled to a carried container 14 with a flexible outer surface 20.

Furthermore, elements may be recited as being “coupled”; this terminology's use contemplates elements being connected together in such a way that there may be other components interstitially located between the specified elements, and that the elements so specified may be connected in fixed or movable relation one to the other. Certain components may be described as being “adjacent” to one another. In these instances, it is expected that a relationship so characterized shall be interpreted to mean that the components are located proximate to one another, but not necessarily in contact with each other. Normally there will be an absence of other components positioned there between, but this is not a requirement. Still further, some structural relationships or orientations may be designated with the word “substantially”. In those cases, it is meant that the relationship or orientation is as described, with allowances for variations that do not effect the cooperation of the so described component or components.

With respect to the above description, it is to be realized that the optimum dimensional relationships for the parts of the invention, to include variations in size, materials, shape, form, function and manner of operations, assembly and use, are deemed readily apparent and obvious to one skilled in the art, and all equivalent relationships to those illustrated in the drawings, and described in the specification, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents are considered to fall within the scope of the invention.

What is claimed and desired to be secured by letters patent is as follows:

1. A container coupling system comprising:
a lifting container comprising a top opening, an outer wall, a maneuvering handle, a set of wheels, a bearing region, and a first coupling portion, wherein said outer wall includes a handling side opposing a loading side, said maneuvering handle is fixed to an upper portion of said outer wall to tilt and maneuver said lifting container, said first coupling portion is located on an upper portion of said loading side, said bearing region is located on said loading side below said first coupling portion, and said set of wheels are fixed to a lower portion of said outer wall on said handling side;
a carried container comprising an outer surface, a second coupling portion, and contact region, wherein said second coupling portion is fixed to an upper portion of said outer surface above said contact region; and
a coupling assembly comprising said first coupling portion, said second coupling portion, said bearing region and said contact region, wherein said coupling assembly is configured to releaseably couple said carried container with said wheeled lifting container, and said contact region is configured to rest against and be supported by said bearing region when said lifting container is tilted and rolled on said set of wheels.

2. The container coupling system as claimed in claim 1, wherein said first coupling portion comprises a pin and said second coupling portion comprises a receiver formed in said carried container, wherein said receiver is adapted to releaseably receive said pin.

3. The container coupling system as claimed in claim 2, wherein said pin has at least three degrees of freedom about which to articulate with respect to said outer wall.

4. The container coupling system as claimed in claim 3, wherein a ball joint provides said degrees of freedom about which to articulate.

5. The container coupling system as claimed in claim 2, wherein said second coupling portion further comprises a guide adjacent to said receiver to encourage alignment and coupling of said pin with said receiver.

6. The container coupling system as claimed in claim 2, wherein an aperture passes through said outer wall adjacent to said pin, said pin is fixed to said outer wall, and said aperture is configured to receive a portion of said second coupling portion when engaging said coupling assembly.

7. The container coupling system as claimed in claim 2, wherein a cavity is formed in said outer wall adjacent to said pin, said pin is fixed to said outer wall, and said cavity is configured to releaseably receive a portion of said second coupling portion when engaging said coupling assembly.

8. The container coupling system as claimed in claim 7, wherein said cavity is removably fixed from said lifting container.

9. The container coupling system as claimed in claim 2, wherein a cavity is formed in said outer wall adjacent to said pin, said pin is fixed inside said cavity and said cavity is configured to releaseably receive a portion of said second coupling portion when engaging said coupling assembly.

10. The container coupling system as claimed in claim 2, wherein said second coupling portion further comprises a carrying handle in which said receiver is formed.

11. The container coupling system as claimed in claim 10, wherein said receiver is further adapted to allow a user to grip said carrying handle.

12. The container coupling system as claimed in claim 2, wherein said first coupling portion further comprises a hinged hook, wherein said pin is located at the end of said hinged hook.

13. The container coupling system as claimed in claim 1, wherein said maneuvering handle is adapted to receive a removably fixed handle extension configured to enhance tilting and maneuvering said lifting container.

14. The container coupling system as claimed in claim 1, wherein said first coupling portion comprises a first coupling bar, and said second coupling portion comprises a second coupling bar, said second coupling bar is mounted horizontally on said outer surface and said first coupling bar is mounted horizontally on said outer wall and adapted to engage a lower region of said second coupling bar when said coupling bars are engaged.

15. The container coupling system as claimed in claim 14, wherein said coupling bars are configured to receive a user's hand.

16. The container coupling system as claimed in claim 14, wherein said second coupling portion further comprises a carrying handle in which said receiver is formed and said second coupling bar is integral with said carrying handle.

17. The container coupling system as claimed in claim 1, wherein said second coupling portion further comprises a coupling bar horizontally mounted on said outer surface, and said first coupling portion further comprises a receiver formed in said outer wall, said receiver configured to releaseably receive and hold said horizontal coupling bar.

18. The container coupling system as claimed in claim 17, wherein said coupling bar is configured to allow a user to grasp said coupling bar.

19. The container coupling system as claimed in claim 1, wherein said first coupling portion further comprises a coupling handle pivotally fixed to said outer surface, and said second coupling portion further comprises a coupling bar fixed to said outer surface, and a lower portion of said coupling bar is configured to releaseably engage said coupling handle.

20. The container coupling system as claimed in claim 1, wherein said first coupling portion further comprises a first coupling handle pivotally fixed to said outer wall, and said second coupling portion further comprises a second coupling handle fixed to said outer surface, said first coupling handle is adapted to releaseably engage a portion of said second coupling handle and said second coupling handle is of sufficient length to make contact with said loading side when engaged with said first coupling handle.

21. The container coupling system as claimed in claim 1, wherein said first coupling portion further comprises a receiver formed in a first coupling handle pivotally fixed to said outer wall, and said second coupling portion further comprises a second coupling handle pivotally fixed to said outer surface, said receiver is adapted to releaseably engage a portion of said second coupling handle.

22. The container coupling system as claimed in claim 2, wherein said pin is fixed to a first coupling handle pivotally fixed to said outer wall, and said receiver is formed to a second coupling handle pivotally fixed to said outer surface.

23. The container coupling system as claimed in claim 1, wherein said lifting container further comprises a lift plate assembly positioned at a lower region of said loading side, said lift plate assembly further comprising a lift plate configured to hold and support a load placed on said lift plate.

24. The container coupling system as claimed in claim 23, wherein said lift plate assembly is removably fixed to said lifting container by a plate pin fixed to said lift plate and a plate receiver formed in said lifting container and further configured to releaseably engage said plate pin.

25. The container coupling system as claimed in claim 24, wherein said lift plate articulates from a substantially vertical stowed position to a substantially horizontal loading position.

26. The container coupling system as claimed in claim 23, wherein said lift plate assembly articulates from a substantially vertical stowed position to a substantially horizontal loading position, said articulation is accomplished by a bolt passing through said lift plate assembly and a bolt receiver formed in said lifting container.

27. The container coupling system as claimed in claim 23, wherein said lift plate assembly is removably fixed to said lifting container by an adaptor plate and at least two adjustable tensionable strap loops and an adjustable tensionable cinch strap, wherein said first strap loop is fixed to an upper portion of said adaptor plate and is of sufficient length to pass over said maneuvering handle, said second strap loop is fixed to an upper portion of said adaptor plate and is of sufficient length to pass around said lifting container, and said cinch strap is fixed between a lower portion of said adaptor plate and said maneuvering handle.

28. The container coupling system as claimed in claim 1, wherein said lifting container further comprises a frame to which said set of wheels are attached and said lifting container is removably attached.

29. The container coupling system as claimed in claim 28, wherein said lift plate assembly further comprises a castor wheel positioned at a periphery of said lift plate to assist in the rolling of said lifting container coupled to said carried container.

30. The container coupling system as claimed in claim 1, wherein said lifting container further comprises a removable frame, said removable frame comprises an upper frame region and a lower frame region, wherein said upper frame region is releaseably attached to said first coupling portion and said lower frame region is releaseably attached to a lower frame receiver formed in a lower region of said lifting container.

31. The container coupling system as claimed in claim 30, wherein said removable frame further comprises a lift plate assembly fixed to said removable frame at a lower region of said frame, said lift plate assembly further comprising a lift plate configured to hold and support a load placed on said lift plate.

32. The container coupling system as claimed in claim 31, wherein said lift plate articulates from a substantially vertical stowed position to a substantially horizontal loading position.

33. The container coupling system as claimed in claim 30, wherein said lifting container further comprises a coupling adaptor fixed to said removable frame, said coupling adaptor configured to act as a said first coupling portion to engage said second coupling portion.

34. The container coupling system as claimed in claim 33, wherein said lifting container further comprises a lift plate assembly fixed to a lower region of said removable frame, said lift plate assembly further comprising a lift plate configured to hold and support a load placed on said lift plate.

35. The container coupling system as claimed in claim 34, wherein said lift plate articulates from a substantially vertical stowed position to a substantially horizontal loading position.

36. The container coupling system as claimed in claim 2, wherein said lifting container further comprises a removable frame, said removable frame comprises an upper frame region, a lower frame region, and a coupling adaptor, wherein said upper frame region releaseably attaches to said pin, said lower frame region is releaseably attached to a lower frame receiver formed in a lower region of said lifting container, and said coupling adaptor is configured to act as a said first coupling portion to engage said second coupling portion.

37. The container coupling system as claimed in claim 2, wherein said lifting container further comprises a removable frame, said removable frame comprises an upper frame region, a lower frame region, and a lift plate assembly; wherein said upper frame region releaseably attaches to said pin, said lower frame region is releaseably attached to a lower frame receiver formed in a lower region of said lifting container, and said lift plate assembly further comprises a lift plate configured to hold and support a load placed on said lift plate.

38. The container coupling system as claimed in claim 37, wherein said lift plate articulates from a substantially vertical stowed position to a substantially horizontal loading position.

39. The container coupling system as claimed in claim 2, wherein said lifting container further comprises a removable frame, said removable frame comprises an upper frame region, a lower frame region, and a coupling adaptor, wherein said upper frame region releaseably attaches to said pin by a receiver formed in said upper frame region, said lower frame region is releaseably attached to a lower frame receiver formed in a lower region of said lifting container; and said coupling adaptor is configured to act as a said first coupling portion to engage said second coupling portion.

40. The container coupling system as claimed in claim 2, wherein said lifting container further comprises a removable frame, said removable frame comprises an upper frame region, a lower frame region, and a lift plate assembly, wherein said upper frame region releaseably attaches to said pin by a receiver formed in said upper frame region, said lower frame region is releaseably attached to a lower frame receiver formed in a lower region of said lifting container; and said lift plate assembly further comprising a lift plate configured to hold and support a load placed on said lift plate.

41. The container coupling system as claimed in claim 40, wherein said lift plate articulates from a substantially vertical stowed position to a substantially horizontal loading position.

42. The container coupling system as claimed in claim 14, wherein said lifting container further comprises a removable frame, said removable frame comprises an upper frame region, a lower frame region, and a coupling adaptor, wherein said upper frame region releaseably attaches to said first coupling bar by a frame coupling bar integral with said upper frame region, said lower frame region is releaseably attached to a lower frame receiver formed in a lower region of said lifting container, and said coupling adaptor configured to act as a said first coupling portion to engage said second coupling portion.

43. The container coupling system as claimed in claim 14, wherein said lifting container further comprises a removable frame, said removable frame comprises an upper frame region, a lower frame region, and a lift plate assembly, wherein said upper frame region releaseably attaches to said first coupling bar by a frame coupling bar integral with said upper frame region, said lower frame region is releaseably attached to a lower frame receiver formed in a lower region of said lifting container, and said coupling adaptor configured to act as a said first coupling portion to engage said second coupling portion, and said lift plate assembly further comprises a lift plate configured to hold and support a load placed on said lift plate.

44. The container coupling system as claimed in claim 43, wherein said lift plate articulates from a substantially vertical stowed position to a substantially horizontal loading position.

45. The container coupling system as claimed in claim 17, wherein said lifting container further comprises a removable frame, said removable frame comprises an upper frame region, a lower frame region, and a coupling adaptor, wherein said upper frame region releaseably engages said receiver by a frame coupling bar integral with said upper frame region, said lower frame region is releaseably attached to a lower frame receiver formed in a lower region of said lifting container and said coupling adaptor configured to act as a said first coupling portion to engage said second coupling portion.

46. The container coupling system as claimed in claim 17, wherein said lifting container further comprises a removable frame, said removable frame comprises an upper frame region, a lower frame region, and a lift plate assembly, wherein said upper frame region releaseably engages said receiver by a frame coupling bar integral with said upper frame region, said lower frame region is releaseably attached to a lower frame receiver formed in a lower region of said lifting container and said lift plate assembly is fixed to a lower region of said removable frame and further comprises a lift plate configured to hold and support a load placed on said lift plate.

47. The container coupling system as claimed in claim 46, wherein said lift plate articulates from a substantially vertical stowed position to a substantially horizontal loading position.

48. The container coupling system as claimed in claim 19, wherein said lifting container further comprises a removable frame, said removable frame comprises an upper frame region, a lower frame region, and a coupling adaptor, wherein said upper frame region releaseably engages said coupling handle by a frame hook fixed to said upper frame region, said lower frame region is releaseably attached to a lower frame receiver formed in a lower region of said lifting container and said coupling adaptor is configured to act as a said first coupling portion to engage said second coupling portion.

49. The container coupling system as claimed in claim 19, wherein said lifting container further comprises a removable frame, said removable frame comprises an upper frame region, a lower frame region, and a lift plate assembly, wherein said upper frame region releaseably engages said coupling handle by a frame hook fixed to said upper frame region, said lower frame region is releaseably attached to a lower frame receiver formed in a lower region of said lifting container and said lift plate assembly is fixed to a lower region of said removable frame and further comprises a lift plate configured to hold and support a load placed on said lift plate.

50. The container coupling system as claimed in claim 49, wherein said lift plate articulates from a substantially vertical stowed position to a substantially horizontal loading position.

51. The container coupling system as claimed in claim 20, wherein said lifting container further comprises a removable frame, said removable frame comprises an upper frame region, a lower frame region, and a coupling adaptor, wherein said upper frame region releaseably attaches to said first coupling handle by a frame hook fixed to said upper frame region, said lower frame region is releaseably attached to a lower frame receiver formed in a lower region of said lifting container and said coupling adaptor is configured to act as a said first coupling portion to engage said second coupling portion.

52. The container coupling system as claimed in claim 20, wherein said lifting container further comprises a removable frame, said removable frame comprises an upper frame region, a lower frame region, and a lift plate assembly, wherein said upper frame region releaseably attaches to said first coupling handle by a frame hook fixed to said upper frame region, said lower frame region is releaseably attached to a lower frame receiver formed in a lower region of said lifting container and said lift plate assembly is fixed to a lower region of said removable frame, and further comprises a lift plate configured to hold and support a load placed on said lift plate.

53. The container coupling system as claimed in claim 52, wherein said lift plate articulates from a substantially vertical stowed position to a substantially horizontal loading position.

54. The container coupling system as claimed in claim 21, wherein said lifting container further comprises a removable frame, said removable frame comprises an upper frame region, a lower frame region, and a coupling adaptor, wherein said upper frame region releaseably attaches to said first coupling handle by a frame hook fixed to said upper frame region and said lower frame region is releaseably attached to a lower frame receiver formed in a lower region of said lifting container and said coupling adaptor configured to act as a said first coupling portion to engage said second coupling portion.

55. The container coupling system as claimed in claim 21, wherein said lifting container further comprises a removable frame, said removable frame comprises an upper frame region, a lower frame region, and a lift plate assembly, wherein said upper frame region releaseably attaches to said first coupling handle by a frame hook fixed to said upper frame region, said lower frame region is releaseably attached to a lower frame receiver formed in a lower region of said lifting container and further comprises a lift plate configured to hold and support a load placed on said lift plate.

56. The container coupling system as claimed in claim 55, wherein said lift plate articulates from a substantially vertical stowed position to a substantially horizontal loading position.

57. The container coupling system as claimed in claim 20, wherein said lifting container further comprises a removable frame, said removable frame comprises an upper frame region, a lower frame region, and a coupling adaptor, wherein said upper frame region releaseably attaches to said receiver by a frame hook fixed to said upper frame region, said lower frame region is releaseably attached to a lower frame receiver formed in a lower region of said lifting container, and said coupling adaptor configured to act as a said first coupling portion to engage said second coupling portion.

58. The container coupling system as claimed in claim 20, wherein said lifting container further comprises a removable frame, said removable frame comprises an upper frame region, a lower frame region, and a lift plate assembly, wherein said upper frame region releaseably attaches to said receiver by a frame hook fixed to said upper frame region, said lower frame region is releaseably attached to a lower frame receiver formed in a lower region of said lifting container and further comprises a lift plate configured to hold and support a load placed on said lift plate.

59. The container coupling system as claimed in claim 58, wherein said lift plate articulates from a substantially vertical stowed position to a substantially horizontal loading position.

60. The container coupling system as claimed in claim 22, wherein said lifting container further comprises a removable frame, said removable frame comprises an upper frame region, a lower frame region and a coupling adaptor, wherein said upper frame region releaseably attaches to said first coupling handle by a frame hook fixed to said upper frame region, said lower frame region is releaseably attached to a lower frame receiver formed in a lower region of said lifting container, and said coupling adaptor configured to act as a said first coupling portion to engage said second coupling portion.

61. The container coupling system as claimed in claim 22, wherein said lifting container further comprises a removable frame, said removable frame comprises an upper frame region, a lower frame region and a lift plate assembly, wherein said upper frame region releaseably attaches to said first coupling handle by a frame hook fixed to said upper frame region, said lower frame region is releaseably attached to a lower frame receiver formed in a lower region of said lifting container and further comprises a lift plate configured to hold and support a load placed on said lift plate.

62. The container coupling system as claimed in claim 61, wherein said lift plate articulates from a substantially vertical stowed position to a substantially horizontal loading position.

63. The container coupling system as claimed in claim 22, wherein said lifting container further comprises a removable frame, said removable frame comprises an upper frame region, a lower frame region, and a coupling adaptor, wherein said upper frame region releaseably attaches to said pin by a receiver formed in said upper frame region, said lower frame region is releaseably attached to a lower frame receiver formed in a lower region of said lifting container, and said coupling adaptor is configured to act as a said first coupling portion to engage said second coupling portion.

64. The container coupling system as claimed in claim 22, wherein said lifting container further comprises a removable frame, said removable frame comprises an upper frame region, a lower frame region, and a lift plate assembly, wherein said upper frame region releaseably attaches to said pin by a receiver formed in said upper frame region, said lower frame region is releaseably attached to a lower frame receiver formed in a lower region of said lifting container and further comprises a lift plate configured to hold and support a load placed on said lift plate.

65. The container coupling system as claimed in claim 64, wherein said lift plate articulates from a substantially vertical stowed position to a substantially horizontal loading position.

66. The container coupling system as claimed in claim 22, wherein said lifting container further comprises a removable frame, said removable frame comprises an upper frame region, a lower frame region, and a coupling adaptor, wherein said upper frame region releaseably attaches to said pin by a frame coupling bar integral to said upper frame region, said lower frame region is releaseably attached to a lower frame receiver formed in a lower region of said lifting container, and said coupling adaptor is configured to act as a said first coupling portion to engage said second coupling portion.

67. The container coupling system as claimed in claim 22, wherein said lifting container further comprises a removable frame, said removable frame comprises an upper frame region, a lower frame region, and a lift plate assembly, wherein said upper frame region releaseably attaches to said pin by a frame coupling bar integral to said upper frame region, said lower frame region is releaseably attached to a lower frame receiver formed in a lower region of said lifting container, and further comprises a lift plate configured to hold and support a load placed on said lift plate.

68. The container coupling system as claimed in claim 67, wherein said lift plate articulates from a substantially vertical stowed position to a substantially horizontal loading position.

69. The container coupling system as claimed in claim 1, wherein said lifting container further comprises a removable frame, said removable frame comprises an upper frame region, a lower frame region, and a coupling adaptor, wherein said upper frame region is releaseably engaged to said maneuvering handle, said lower frame region is releaseably engaged to a lower frame receiver formed in a lower region of said lifting container, and said coupling adaptor is configured to act as a said first coupling portion to engage said second coupling portion.

70. The container coupling system as claimed in claim 1, wherein said lifting container further comprises a removable frame, said removable frame comprises an upper frame region, a lower frame region, and a lift plate assembly, wherein said upper frame region is releaseably engaged to said maneuvering handle, said lower frame region is releaseably engaged to a lower frame receiver formed in a lower region of said lifting container, and further comprises a lift plate configured to hold and support a load placed on said lift plate.

71. The container coupling system as claimed in claim 70, wherein said lift plate articulates from a substantially vertical stowed position to a substantially horizontal loading position.

72. The container coupling system as claimed in claim 1, wherein said lifting container further comprises a removeable liner with an open end and a closeable door covering said open end, said removable liner extending into said carrying container and removably fixed at said one open end to said top opening by a removeable liner mount.

73. The container coupling system as claimed in claim 2, wherein said outer surface is flexible and an upending handle is positioned at a lower region of said carried container.

74. The container coupling system as claimed in claim 1, wherein a supplemental first coupling portion is positioned on said outer wall between said maneuvering handle and said first coupling portion.

75. The container coupling system as claimed in claim 1, wherein said lifting container further comprises a vertical bumper positioned on said outer wall at said loading side, wherein an upper portion of said vertical bumper encourages a minimum separation distance between said lifting container and said carried container needed to couple said coupling assembly, and said bearing region is located at a lower portion of said vertical bumper to encourage a minimum separation distance between said lifting container and said carried container.

76. The container coupling system as claimed in claim 1, wherein said carried container further comprises a vertical bumper positioned on said outer surface running between a position adjacent to said second coupling portion and a lower end of said carried container, wherein an upper portion of said vertical bumper encourages a minimum separation distance between said lifting container and said carried container needed to couple said coupling assembly, and said contact region is located at a lower portion of said vertical bumper to encourage a minimum separation distance between said lifting container and said carried container.

77. The container coupling system as claimed in claim 1, wherein said lifting container further comprises a horizontal bumper positioned on and extending away from said outer wall below said first coupling portion, wherein said bearing region is located on a distal region of said horizontal bumper and encourages a minimum separation distance between said lifting container and said carried container needed to couple said coupling assembly.

78. The container coupling system as claimed in claim 77, wherein said distal region of said horizontal bumper is arcuate to encourage proper alignment of said outer surfaces which are curved.

79. A coupling system for a modular container system, wherein each modular container to be coupled comprises:
an outer wall forming a modular container with a top opening, said outer wall comprising a handling side opposite a loading side;
a set of wheels fixed at lower region of said handling side;
a maneuvering handle fixed at an upper region of said handling side above said wheels, said maneuvering handle and set of wheels positioned on said handling side to allow tilting back and rolling of said modular container on said set of wheels;
at least one first coupling portion fixed at said loading side;
at least one second coupling portion fixed at a handling side;
a contact region located below said second coupling portion; and
a bearing region located below said first coupling portion, wherein said first coupling portion is configured to releaseably couple with a corresponding said second coupling portion of an adjacent modular wheeled container and said bearing region is configured to support a corresponding said contact region of said adjacent modular wheeled container when said modular wheeled containers are tilted onto one set of said wheels.

80. The container coupling system as claimed in claim 79, wherein said first coupling portion comprises a pin and said second coupling portion comprises a receiver formed in said maneuvering handle, wherein said receiver is adapted to releaseably receive a corresponding said pin of another said modular container.

81. The container coupling system as claimed in claim 80, wherein said pin has at least three degrees of freedom about which to articulate with respect to said outer wall.

82. The container coupling system as claimed in claim 81, wherein a ball joint provides said degrees of freedom about which to articulate.

83. The container coupling system as claimed in claim 80, wherein said second coupling portion further comprises a guide adjacent to said receiver to encourage alignment and coupling of said another modular container.

84. The container coupling system as claimed in claim 80, wherein an aperture passes through said outer wall adjacent to said pin, said pin is fixed to said outer wall, and said aperture is configured to receive a portion of a corresponding said second coupling portion.

85. The container coupling system as claimed in claim 80, wherein a cavity is formed in said outer wall adjacent to said pin, said pin is fixed to said outer wall, and said cavity is configured to releaseably receive a portion of a corresponding said second coupling portion.

86. The container coupling system as claimed in claim 85, wherein said cavity is removably fixed from said outer wall.

87. The container coupling system as claimed in claim 80, wherein a cavity is formed in said outer wall adjacent to said pin, said pin is fixed inside said cavity and said cavity is configured to releaseably receive a portion of a corresponding said second coupling portion.

88. The container coupling system as claimed in claim 80, wherein said first coupling portion further comprises a hinged hook, wherein said pin is located at the end of said hinged hook.

89. The container coupling system as claimed in claim 79, wherein said maneuvering handle is adapted to receive a removably fixed handle extension configured to enhance tilting and maneuvering said lifting container.

90. The container coupling system as claimed in claim 79, wherein said first coupling portion comprises a first coupling bar, and said second coupling portion comprises a second coupling bar, said second coupling bar is mounted horizontally on said handling side and said first coupling bar is mounted horizontally on said loading side to engage a lower region of a corresponding said second coupling bar.

91. The container coupling system as claimed in claim 90, wherein said second coupling bar is integral with said maneuvering handle.

92. The container coupling system as claimed in claim 79, wherein said second coupling portion further comprises a horizontal coupling bar integral with said maneuvering handle and said first coupling portion further comprises a receiver found in said outer wall on said loading side, and said receiver configured to releaseably receive and hold a corresponding said horizontal coupling bar.

93. The container coupling system as claimed in claim 79, wherein said first coupling portion further comprises a coupling handle pivotally fixed to said loading side, and said second coupling portion further comprises a coupling bar fixed to said handling side, and a lower portion of said coupling bar is configured to releaseably engage a corresponding said coupling handle.

94. The container coupling system as claimed in claim 79, wherein said first coupling portion further comprises a first coupling handle pivotally fixed to said loading side, and said second coupling portion further comprises said maneuvering handle, said coupling handle is adapted to releaseably engage a portion of a corresponding said maneuvering handle and a corresponding said maneuvering handle is of sufficient length to make contact with said loading side when engaged with said first coupling handle.

95. The container coupling system as claimed in claim 79, wherein said first coupling portion further comprises a receiver formed in a first coupling handle pivotally fixed to said outer wall, and said second coupling portion further comprises said maneuvering handle, said receiver is adapted to releaseably engage a portion of a corresponding said maneuvering handle.

96. The container coupling system as claimed in claim 80, wherein said pin is fixed to a first coupling handle pivotally fixed to said loading side, and said receiver is formed in said maneuvering handle.

97. The container coupling system as claimed in claim 79, wherein said lifting container further comprises a lift plate assembly positioned at a lower region of said loading side, said lift plate assembly further comprising a lift plate configured to hold and support a load placed on said lift plate.

98. The container coupling system as claimed in claim 97, wherein said lift plate assembly is removably fixed to said lifting container by a plate pin fixed to said lift plate and a plate receiver formed in said modular container and further configured to releaseably engage said plate pin.

99. The container coupling system as claimed in claim 98, wherein said lift plate articulates from a substantially vertical stowed position to a substantially horizontal loading position.

100. The container coupling system as claimed in claim 97, wherein said lift plate assembly articulates from a substantially vertical stowed position to a substantially horizontal loading position, said articulation is accomplished by a bolt passing through said lift plate assembly and a bolt receiver formed in said modular container.

101. The container coupling system as claimed in claim 97, wherein said lift plate assembly is removably fixed to said modular container by an adaptor plate and at least two adjustable tensionable strap loops and an adjustable tensionable cinch strap, wherein said first strap loop is fixed to an upper portion of said adaptor plate and is of sufficient length to pass over said maneuvering handle, said second strap loop is fixed to an upper portion of said adaptor plate and is of sufficient length to pass around said modular container, and said cinch strap is fixed between a lower portion of said adaptor plate and said maneuvering handle.

102. The container coupling system as claimed in claim 79, wherein said lifting container further comprises a frame to which said set of wheels are attached and said modular container is removably attached.

103. The container coupling system as claimed in claim 102, wherein said lift plate assembly further comprises a castor wheel positioned at a periphery of said lift plate to assist in the rolling of coupled modular containers.

104. The container coupling system as claimed in claim 79, wherein said modular container further comprises a removable frame, said removable frame comprises an upper frame region and a lower frame region, wherein said upper frame region is releaseably attached to said first coupling portion and said lower frame region is releaseably attached to a lower frame receiver formed in a lower region of said modular container.

105. The container coupling system as claimed in claim 104, wherein said removable frame further comprises a lift plate assembly fixed to said removable frame at a lower region of said frame, said lift plate assembly further comprising a lift plate configured to hold and support a load placed on said lift plate.

106. The container coupling system as claimed in claim 104, wherein said modular container further comprises a coupling adaptor fixed to said removable frame, said coupling adaptor configured to act as a said first coupling portion to engage a corresponding said second coupling portion.

107. The container coupling system as claimed in claim 106, wherein said modular container further comprises a lift plate assembly fixed to a lower region of said removable frame, said lift plate assembly further comprising a lift plate configured to hold and support a load placed on said lift plate.

108. The container coupling system as claimed in claim 80, wherein said modular container further comprises a removable frame, said removable frame comprises an upper frame region, a lower frame region, and a coupling adaptor, wherein said upper frame region releaseably attaches to said pin, said lower frame region is releaseably attached to a lower frame receiver formed in a lower region of said modular container, and said coupling adaptor is configured to act as a said first coupling portion to engage a corresponding said second coupling portion.

109. The container coupling system as claimed in claim 80, wherein said modular container further comprises a removable frame, said removable frame comprises an upper frame region, a lower frame region, and a lift plate assembly; wherein said upper frame region releaseably attaches to said pin, said lower frame region is releaseably attached to a lower frame receiver formed in a lower region of said modular container, and said lift plate assembly further comprises a lift plate configured to hold and support a load placed on said lift plate.

110. The container coupling system as claimed in claim 80, wherein said modular container further comprises a removable frame, said removable frame comprises an upper frame region, a lower frame region, and a coupling adaptor, wherein said upper frame region releaseably attaches to said pin by a receiver formed in said upper frame region, said lower frame region is releaseably attached to a lower frame receiver formed in a lower region of said modular container; and said coupling adaptor is configured to act as a said first coupling portion to engage a corresponding said second coupling portion.

111. The container coupling system as claimed in claim 80, wherein said modular container further comprises a removable frame, said removable frame comprises an upper frame region, a lower frame region, and a lift plate assembly, wherein said upper frame region releaseably attaches to said pin by a receiver formed in said upper frame region, said lower frame region is releaseably attached to a lower frame receiver formed in a lower region of said modular container; and said lift plate assembly further comprising a lift plate configured to hold and support a load placed on said lift plate.

112. The container coupling system as claimed in claim 90, wherein said modular container further comprises a removable frame, said removable frame comprises an upper frame region, a lower frame region, and a coupling adaptor, wherein said upper frame region releaseably attaches to said first coupling bar by a frame coupling bar integral with said upper frame region, said lower frame region is releaseably attached to a lower frame receiver formed in a lower region of said modular container, and said coupling adaptor configured to act as a said first coupling portion to engage a corresponding said second coupling portion.

113. The container coupling system as claimed in claim 90, wherein said modular container further comprises a removable frame, said removable frame comprises an upper frame region, a lower frame region, and a lift plate assembly, wherein said upper frame region releaseably attaches to said first coupling bar by a frame coupling bar integral with said upper frame region, said lower frame region is releaseably attached to a lower frame receiver formed in a lower region of said modular container, and said coupling adaptor configured to act as a said first coupling portion to engage a corresponding said second coupling portion, and said lift plate assembly further comprises a lift plate configured to hold and support a load placed on said lift plate.

114. The container coupling system as claimed in claim 92, wherein said modular container further comprises a removable frame, said removable frame comprises an upper frame region, a lower frame region, and a coupling adaptor, wherein said upper frame region releaseably engages said receiver by a frame coupling bar integral with said upper frame region, said lower frame region is releaseably attached to a lower frame receiver formed in a lower region of said modular container and said coupling adaptor configured to act as a said first coupling portion to engage a corresponding said second coupling portion.

115. The container coupling system as claimed in claim 92, wherein said modular container further comprises a removable frame, said removable frame comprises an upper frame region, a lower frame region, and a lift plate assembly, wherein said upper frame region releaseably engages said receiver by a frame coupling bar integral with said upper frame region, said lower frame region is releaseably attached to a lower frame receiver formed in a lower region of said modular container and said lift plate assembly is fixed to a lower region of said removable frame and further comprises a lift plate configured to hold and support a load placed on said lift plate.

116. The container coupling system as claimed in claim 93, wherein said modular container further comprises a removable frame, said removable frame comprises an upper frame region, a lower frame region, and a coupling adaptor, wherein said upper frame region releaseably engages said coupling handle by a frame hook fixed to said upper frame region, said lower frame region is releaseably attached to a lower frame receiver formed in a lower region of said modular container and said coupling adaptor is configured to act as a said first coupling portion to engage a corresponding said second coupling portion.

117. The container coupling system as claimed in claim 93, wherein said modular container further comprises a removable frame, said removable frame comprises an upper frame region, a lower frame region, and a lift plate assembly, wherein said upper frame region releaseably engages said coupling handle by a frame hook fixed to said upper frame region, said lower frame region is releaseably attached to a lower frame receiver formed in a lower region of said modular container and said lift plate assembly is fixed to a lower region of said removable frame and further comprises a lift plate configured to hold and support a load placed on said lift plate.

118. The container coupling system as claimed in claim 94, wherein said modular container further comprises a removable frame, said removable frame comprises an upper frame region, a lower frame region, and a coupling adaptor, wherein said upper frame region releaseably attaches to said first coupling handle by a frame hook fixed to said upper frame region, said lower frame region is releaseably attached to a lower frame receiver formed in a lower region of said modular container and said coupling adaptor is configured to act as a said first coupling portion to engage a corresponding said second coupling portion.

119. The container coupling system as claimed in claim 94, wherein said modular container further comprises a removable frame, said removable frame comprises an upper frame region, a lower frame region, and a lift plate assembly, wherein said upper frame region releaseably attaches to said first coupling handle by a frame hook fixed to said upper frame region, said lower frame region is releaseably attached to a lower frame receiver formed in a lower region of said modular container and said lift plate assembly is fixed to a lower region of said removable frame, and further comprises a lift plate configured to hold and support a load placed on said lift plate.

120. The container coupling system as claimed in claim 95, wherein said modular container further comprises a removable frame, said removable frame comprises an upper frame region, a lower frame region, and a coupling adaptor, wherein said upper frame region releaseably attaches to said first coupling handle by a frame hook fixed to said upper frame region and said lower frame region is releaseably attached to a lower frame receiver formed in a lower region of said modular container and said coupling adaptor configured to act as a said first coupling portion to engage a corresponding said second coupling portion.

121. The container coupling system as claimed in claim 95, wherein said modular container further comprises a removable frame, said removable frame comprises an upper frame region, a lower frame region, and a lift plate assembly, wherein said upper frame region releaseably attaches to said first coupling handle by a frame hook fixed to said upper frame region, said lower frame region is releaseably attached to a lower frame receiver formed in a lower region of said modular container and further comprises a lift plate configured to hold and support a load placed on said lift plate.

122. The container coupling system as claimed in claim 95, wherein said modular container further comprises a removable frame, said removable frame comprises an upper frame region, a lower frame region, and a coupling adaptor, wherein said upper frame region releaseably attaches to said receiver by a frame hook fixed to said upper frame region, said lower frame region is releaseably attached to a lower frame receiver formed in a lower region of said modular container, and said coupling adaptor configured to act as a said first coupling portion to engage a corresponding said second coupling portion.

123. The container coupling system as claimed in claim 95, wherein said modular container further comprises a removable frame, said removable frame comprises an upper frame region, a lower frame region, and a lift plate assembly, wherein said upper frame region releaseably attaches to said receiver by a frame hook fixed to said upper frame region, said lower frame region is releaseably attached to a lower frame receiver formed in a lower region of said modular container and further comprises a lift plate configured to hold and support a load placed on said lift plate.

124. The container coupling system as claimed in claim 79, wherein said lifting container further comprises a removable frame, said removable frame comprises an upper frame region, a lower frame region, and a lift plate assembly, wherein said upper frame region is releaseably engaged to said maneuvering handle, said lower frame region is releaseably engaged to a lower frame receiver formed in a lower region of said lifting container, and further comprises a lift plate configured to hold and support a load placed on said lift plate.

125. The container coupling system as claimed in claim 79, wherein said lifting container further comprises a removeable liner with an open end and a closeable door covering said open end, said removable liner extending into said carrying container and removably fixed at said one open end to said top opening by a removeable liner mount.

126. The container coupling system as claimed in claim 79, wherein said modular container further comprises a vertical bumper positioned on said outer wall at a handling side, wherein an upper portion of said vertical bumper encourages a minimum separation distance between coupling of said modular containers, and said bearing region is located at a lower portion of said vertical bumper to encourage a minimum separation distance between coupled said modular containers.

127. The container coupling system as claimed in claim 79, wherein said modular container further comprises a vertical bumper positioned on said outer wall at a handling side, wherein an upper portion of said vertical bumper encourages a minimum separation distance between coupling of said modular containers, and said contact region is located at a lower portion of said vertical bumper to encourage a minimum separation distance between coupled said modular containers.

128. The container coupling system as claimed in claim 79, wherein said modular container further comprises a horizontal bumper positioned on and extending away from said outer wall below said first coupling portion, wherein said bearing region is located on a distal region of said horizontal bumper and encourages a minimum separation distance between coupled said modular containers.

129. The container coupling system as claimed in claim 128, wherein said distal region of said horizontal bumper is arcuate to encourage proper alignment of coupled said modular containers with curved outer walls.
